(19) United States
(12) Patent Application Publication
(10) Pub. No.: US 2026/0233216 A1
(43) Pub. Date: Aug. 13, 2026

(54) PENETRABLE GEL IN A REACTION VESSEL

(71) Applicant: ATILA BIOSYSTEMS INCORPORATED, PALO ALTO, CA (US)

(72) Inventors: Yining SHI, Sunnyvale, CA (US); Youxiang WANG, Sunnyvale, CA (US); Rong WANG, Sunnyvale, CA (US); Zhijie YANG, Sunnyvale, CA (US); Xin CHEN, Sunnyvale, CA (US); Jialuo LI, Sunnyvale, CA (US); Bo JIANG, Sunnyvale, CA (US); Soo Khim CHAN, Sunnyvale, CA (US); Soma CHAUDHARY, Sunnyvale, CA (US); Yifan CHEN, Sunnyvale, CA (US); Bin LI, Sunnyvale, CA (US)

(21) Appl. No.: 19/471,235

(22) PCT Filed: May 15, 2024
(86) PCT No.: PCT/US2024/029451

§ 371 Date: Sep. 30, 2025

Related U.S. Application Data
(60) Provisional application No. 63/466,982, filed on May 16, 2023.

(51) Int. Cl. B01L 3/00

(52) U.S. Cl. CPC B01L 3/50215; B01L 2200/028; B01L 2200/141; B01L 2200/16; B01L 2300/0645; B01L 2300/0829; B01L 2300/161; B01L 2300/1822; B01L 2400/043; B01L 2400/0442

(57) ABSTRACT

The invention uses gel layers to cover and/or separate one or more aqueous reaction mixtures in a reaction vessel. A gel layer can protect reagents or reaction products from contacting the atmosphere. A gel layer can also separate multiple aqueous reaction mixtures so that they do not contact one another until the gel layer is broken. An oil layer can be inserted immediately underneath a gel layer. Gel layers can be penetrated by insertion of a tip from a micropipette to deliver a solution, such as a sample, below a gel layer. Micropipette tips or inert rods can also be used to disrupt gel layers resulting in mixing of aqueous reaction mixtures above and below a layer. Gel layers can also be broken by selective application of heat or movement of magnetic beads. Multiple gel layers separating multiple aqueous reagent mixtures can be broken in a defined sequence for an ordered series of bioprocessing steps.

### CROSS-REFERENCE TO RELATED APPLICATION

The present application claims the benefit of U.S. Application No. 63/466,982; Filed: May 16, 2023, which is incorporated by reference in its entirety for all purposes.

### BACKGROUND

Amplification reactions such as polymerase chain reaction (PCR), as well as several other commonly performed laboratory detection assays (e.g., immunoassays) involve multiple aqueous reaction mixtures that are maintained separately from one another until predetermined steps of the assay are performed. Separation can be affected by separate vessels containing a stock of each aqueous reaction mixture in a kit, which are then distributed to the appropriate reaction vessel by the experimenter. However, such methods risk contamination of the stock aqueous reaction mixtures and provide opportunities for human error in preparing the individual assay reactions (e.g., forgetting to add a reaction mixture to a sample, adding a mixture twice and disrupting necessary ratios/concentrations of reagents, causing contamination before, during or after the reactions). Even when no errors arise, such methods still require significant time and effort if preparing reactions for a large experiment, such as, for example, preparing a 96-well or 384-well PCR plate reactions. Therefore, there is a need to simplify the procedures of performing PCR assays and reduce the cold chain involvement during transport of reagent products to the end user when multiple subsets of reagents (e.g., primer subset and enzyme subset) and or multiple steps (e.g., RT-PCR) are involved. Therefore, reagent products supplied in the format of ready-to-use or “just-add-sample,” as well as being transported at ambient temperature are desirable to eliminate human procedural error, increase assay speed and precision, and save transport cost without compromising performance of the reagents.

False results due to lab contamination before, during or after the reaction have always been a concern. Several solutions have been proposed to address this issue, particularly for PCR reactions. For example, Johnson et al. described the use of lyophilized pellets of reagent materials (see, e.g., U.S. Pat. Nos. 10,144,954 and 11,098,344). One of the inherent issues with lyophilization, or freeze-drying, is maintaining sufficiently low moisture levels in the lyophilized reagent to ensure functionality on reconstitution. Johnson reported coating or impregnating the lyophilized reagent components with a wax component for this purpose. However, the wax required heating to a certain temperature in the thermocycler to release the lyophilized reagents into the aqueous components of the PCR reaction added by experimenter. Although acceptable for standard thermocycler-based PCR methods with a high temperature denaturing step, newer isothermal PCR methods may not reach sufficient temperatures to release lyophilized reagents and facilitate their reconstitution. More recent attempts to optimize amplification reactions have attempted to select the best attributes of prior optimization techniques and combine them into a ready-to-use format that requires only sample addition (see, e.g., WO 2022/026670). Although such methods would seemingly reduce problematic aspects of PCR reactions that include extensive sample preparation and time consuming and error prone steps, as discussed above, these methods ultimately rely on proprietary and specialized equipment to perform specific point-of-care assays with defined reaction cartridges.

Earlier attempts to optimize PCR reactions also employed wax and other immiscible hydrophobic substances like mineral and silicon oils or various inert greases, with two main aims: (1) to prevent evaporation from the PCR mixture during thermocycling to ensure a consistent reaction volume and fidelity between reactions; and (2) avoiding non-specific PCR products produced by mis-priming (e.g., primer dimers and oligomerization) on mixing of PCR reagents at ambient temperatures, as such events can occur well below the temperatures of thermal cycling that occur during the PCR reaction (U.S. Pat. Nos. 5,411,876). This patent reports the use of grease or wax to contain two subsets of PCR reagent in a segregated manner for improved shelf-life of PCR reagents and increase protection of laboratory environment against contamination by PCR product. Improvements to the PCR are accomplished by changing the way that PCR reagents are mixed: mixing of the grease or wax-segregated subsets of the reagent does not occur until the first heating step of a PCR amplification which melts and liquifies the grease or wax barrier that segregates the subsets of the reagent. When the grease or wax melts into a lighter-than-water liquid during the first amplification cycle, mutual displacement of the melted grease or wax and aqueous layer occurs and resulting convective mixing of the now merged aqueous reagents and subsequent amplification reactions. However, even the improved wax layering with hydrophilic surface treated tubes as described in Example 5 of U.S. Pat. No. 5,411,876 fail to generate PCR products that are comparable to the mineral oil control, in terms of yield of target product and amount of non-specific primer dimer: 1) three of the fifteen reactions with the wax format showed significantly less of specific product than the others, whereas all the six oil controls show somewhat higher yields of specific product than does the wax format; and 2) wax gives somewhat larger primer dimer than does oil, and somewhat higher yields of primer dimer than does oil.

U.S. Pat. No. 5,576,197 reported a PCR container preloaded with wax attached to the inside surface positioned at or above an estimated meniscus position of a PCR mixture. The wax melts at PCR temperatures and covers the surface of the PCR mixture thereby preventing evaporation during thermal cycling. According to this patent, other similar methods, such as small solid wax ball and microtube containing solid wax at the bottom of the tube, suffer from these major drawbacks: for the former, loading individual wax balls to each reaction tube is prone to contamination, tedious and time consuming; for the latter, the wax and the PCR mixture must be phase inversed by centrifugation, and incomplete phase inversion is problematic and challenging to resolve. Although U.S. Pat. No. 5,576,197 attempts to address the above issues, it is impractical to mass-produce microtubes that contain the precisely positioned wax inside the microtube with good yield. This manufacturing challenge is further intensified when a microtube of small volume, e.g., 0.1 mL, is involved. Additionally, use of the resultant microtube is user-unfriendly, because loading reaction mixture through the small lumen of the wax-tube container is tedious and the wax mass may clog the pipette tips or detach from the inner wall of the tube due to imprecise pipette positioning.

Furthermore, many of these methods simply reintroduced standard PCR drawbacks in different aspects of the reaction process, i.e., instead of possibly contaminating stocks of reaction mixture reagents, there was now a risk of contamination of inert oil or greases being applied to multiple samples. The addition of these components was time-consuming as well as problematic in requiring pipetting of an oily substance. Finally, these methods are also unsuitable to isothermal amplification reactions because they rely on high temperature initial steps in a thermocycler to release and mix separated components.

The coronavirus disease pandemic beginning 2019 (COVID-19) highlights bottlenecks in large-scale, frequent testing of populations for infections. To address this challenge, Batas et al. describe a wax layered reagent system that is close to the concept of “just-add-sample” for point of care diagnostic testing and thermally stable for transport without using cold chain packaging (Batas et al. Accessible LAMP-Enabled Rapid Test (ALERT) for Detecting SARS-COV-2, Viruses 2021, 13, 742). In this wax reagent system, multiple layers of paraffin wax and silicon wax are used to isolate and package all the RT-LAMP (reverse transcription loop-mediated isothermal amplification) reagent components in one PCR tube. While the resultant wax layered reagents are found to be stable under transport condition of room temperature and performing to test clinical COVID-19 samples, faint fluorescence is observed in some samples, and more importantly, the negative predict value and positive predict value are only 60% and 74%, respectively, which is far below than those of the freshly prepared liquid reagents. As indicated by the authors, these underperformance findings may be ascribable to the lack of homogeneous mixing of all the reagent components owing to a pipette-free operation. Another prominent drawback of this wax layered system is the requirement of multiple manual steps involving off-line wax layer melting and vortex before loading it in a thermal instrument for isothermal reactions.

To control the carryover contamination in amplification reactions, a method, alternative to the physical barrier such as mineral oil or paraffin wax, is the use of uracil DNA glycosylase in PCR where dTTP is substituted by dUTP to produce uracil-containing DNA (U-DNA). Treating subsequent PCR reaction mixtures with Uracil-DNA Glycosylase (UNG) prior to PCR amplification and subsequent cleavage of apyrimidinic polynucleotides at elevated temperature (e.g., 95° C.) under alkaline conditions (during the initial denaturation step) will remove contaminating U-DNA from the sample. (Longo et al., Use of uracil DNA glycosylase to control carry-over contamination in polymerase chain reactions. Gene). In other words, the presence of dUTP in the DNA distinguishes the PCR product (i.e., an amplicon) from the native DNA template. Because the native template does not have dUTP, it remains intact in the presence of the enzyme. But any amplicon DNA that contains dUTP is susceptible to enzymatic cleavage action.

To be effective as a strategy, however, the UNG method requires that all PCR reactions in the lab be carried out with dUTP instead of dTTP which may not be practical in a clinical setting. Moreover, complete elimination of contaminants is not always accomplished with this technique, particularly when the PCR product length is short, which is a common situation in real-time PCR assays. In addition, there is the possibility, especially when the initial sample contains only one or a few target molecules, that inclusion of UNG may reduce amplification efficiency, thereby delaying or preventing detection of the targets (Pierce and Wangh, Effectiveness and limitations of uracil-DNA glycosylases in sensitive real-time PCR assays, Biotechniques 2004 January;36(1):44-6, 48). Other shortcomings of this strategy, compared with the conventional PCR technique, may include extra material cost and tedious assay development efforts involved in the use of this chemistry-based method for carryover contamination suppression.

In view of the above, a need exists for a compartmentalized reaction vessel that is ready-to-use, performs comparably to a liquid format with a conventional PCR tube or ELISA microtiter plates, is thermally and mechanically stable for transport at ambient or sub-ambient temperature, long-lasting in shelf life at freezing temperature or ambient or sub-ambient storage temperature conditions, and able to form a non-flowable seal in the vessel after reactions for prevention of carryover contamination by the reaction product(s). The present invention provides these and other features individually and in combinations as will be apparent from review of the following.

### SUMMARY OF THE CLAIMED INVENTION

The invention provides a reaction vessel comprises a gel layer penetrable by a micropipette tip disposed within the vessel. Optionally, the reaction vessel further comprises one or more additives in the gel layer and mineral oil underneath the gel layer. Optionally, the reaction vessel further comprises a liquid aqueous reaction mixture above and/or below and/or or within the gel layer. Optionally, the liquid aqueous reaction mixture(s) are for detection of an analyte. Optionally, the liquid aqueous reaction mixture is below the gel layer, the gel layer resists dispersal of the liquid aqueous reaction mixture across the gel layer, and the gel layer is penetrable by a micropipette tip to deliver a solution to the reaction mixture for a reaction to detect an analyte. Optionally, the delivered solution is a sample including the analyte. Optionally, the gel layer resists dispersal of the liquid aqueous reaction mixture across the gel layer and is penetrable by a micropipette tip at least within a temperature range of 18-35° C. (e.g., 20-35° C. or 20-25° C.). Optionally, the reaction vessel comprises multiple gel layers, multiple oil layers, and multiple liquid aqueous reaction mixture layers, the number of gel layers differing from the number of oil layers, and/or from the number of liquid aqueous reaction mixture layers. Optionally, the micropipette comprises a single tip or multiple tips or a bundle of capillaries.

Optionally, the reaction vessel comprises a first liquid aqueous reaction mixture, a first gel layer penetrable by a micropipette tip covering the first liquid aqueous reaction mixture, a second liquid aqueous reaction mixture over the first gel layer, and a second gel layer penetrable by a micropipette tip covering the second liquid aqueous solution, and optionally, a first layer of mineral oil between the first liquid aqueous reaction mixture and the first gel layer, and optionally, a second layer of mineral oil between the second liquid aqueous reaction mixture and the second gel layer. Optionally, one of the first and second liquid aqueous reaction mixtures is a sample and the other contains one or more reagents for performing a reaction to detect an analyte in the sample when first and second liquid aqueous reaction mixtures are combined. Optionally, the first liquid aqueous reaction mixture and the second liquid aqueous reaction mixtures are each partial reaction mixtures which when combined with each other and a sample result in a detection reaction. Optionally, a third liquid aqueous reaction mixture is present above the second gel layer and the multiple liquid aqueous reaction mixtures contain reagents for performing ordered bioprocessing steps. Optionally, the multiple liquid aqueous reaction mixtures are for performing nucleic acid sequencing library preparation or nucleic acid sample extraction or immunoassay, or biochemistry or nucleic acid amplification and detection. Optionally, the first liquid aqueous reaction mixture and second liquid aqueous reaction mixture contain polymerases and primers respectively or vice versa for nucleic acid detection with PCR amplification, qPCR amplification, reverse transcriptase PCR reaction or digital PCR amplification or isothermal amplification. Optionally, the first liquid aqueous reaction mixture and second liquid aqueous reaction mixture contain different reagents, which in combination with each other and sample are required for a detection reaction.

Optionally, the combination of the first liquid aqueous reaction mixture and the second liquid aqueous reaction mixture is for performing an immunoassay and detection, optionally a third aqueous solution is above the second gel layer for sequential reactions. Optionally, the liquid aqueous reaction mixture contains magnetic beads.

Optionally, the reaction vessel is coupled to a slidable heater module along the exterior of the reaction vessel for melting the gel layer when the heater adjacent to the gel layer. Optionally, the reaction vessel is coupled to a slidable magnetic module along an exterior or interior surface of the reaction vessel for moving magnetic beads from a liquid aqueous reaction mixture across a layer of the gel underneath the liquid aqueous reaction mixture. Optionally, the slidable magnetic module is slidable along the interior of the reaction vessel and is linked to a rod to detect a reaction in the reaction vessel.

Optionally, the liquid aqueous reaction mixture comprises a rod for detection of a reaction in the reaction vessel. Optionally, the rod is an electrode. Optionally, the reaction vessel is a well in a multi-well plate (e.g., a PCR plate or deep well plate or microtiter plate or ELISA plate), each of the wells containing a gel layer. Optionally, the reaction vessel is a tube or tubing (e.g., a PCR tube) disposed singularly or as a strip or matrix, comprising a plurality of the vessel interconnected to one another. Optionally, the reaction vessel is a plastic, glass or metal with one or multiple trenches or channels.

Optionally, the reaction vessel is a well on a chip or tubing (e.g., glass slides or silicon wafers or plastic slides or metal slides), optionally having multiple wells providing multiple reaction vessels, and optionally the multiple wells are connected by channels, and optionally the wells contain a piece of membrane or glass fiber.

Optionally, an inner surface of the reaction vessel is hydrophobic or hydrophilic.

Optionally, the gel layer is made of an inorganic or organic or combination of inorganic and organic polymer gel matrix or is a mixture of wax and mineral oil or silicon oil in a ratio from 25:75 to 75:25 by weight with or without surfactant additives.

The invention further provides a method of performing a reaction comprising providing a reaction vessel as defined above and penetrating the layer of the gel with a micropipette tip to deliver a solution from the micropipette tip, whereby a reaction occurs. Optionally, the solution comprises a sample, and optionally reaction reagents. Optionally, the gel layer melts during and after the reaction and re-solidifies thereafter. Optionally, the method further comprises disrupting the gel layer with an inert rod or a micropipette tip with a plug in it before penetrating the gel with the micropipette tip to deliver one or more liquid aqueous reaction mixtures to the reaction vessel. Optionally, the plug in the tip is wax or gel. Optionally, the reaction vessel comprises a first liquid aqueous reaction mixture below a first gel layer and a second liquid aqueous reaction mixture above the first gel layer, and a second gel layer above the second liquid aqueous reaction mixture and the method comprises penetrating the gel layers with an inert rod or a micropipette tip to mix the first liquid aqueous reaction mixture and the second liquid aqueous reaction mixture, whereby the reaction vessel comprises a mixed reaction mixture covered by a third gel layer formed from the first and second gel layers and the method further comprises penetrating the third gel layer with the micropipette tip to deliver the solution from the micropipette tip to the mixed reaction mixture. Optionally, the method further comprises centrifuging the reaction vessel to facilitate mixing the reaction mixtures between the gel layers. Optionally, the solution is a liquid aqueous reaction mixture comprising all reaction reagents including a sample for a reaction to detect a target in the sample or partial reaction reagents for a reaction to detect a target in the sample. Optionally, the liquid aqueous reaction mixture is delivered into an oil layer or gel layer to form emulsion droplets or other reaction compartments for droplet digital PCR reaction or droplet immunoassay PCR reactions.

The invention further provides a method of performing a reaction comprising providing a reaction vessel as defined by claim 1 and solutions placed above and beneath the gel layer, and displacing or melting the gel layer, whereby the solutions mix and a reaction occurs.

The invention further provides a reaction vessel comprising a plurality of liquid aqueous reaction mixtures separated from one another by a plurality of gel layers disposed with the reaction vessel, wherein the plurality of liquid aqueous reaction mixtures are combinable by melting and/or disruption of the gel layers to perform a series of processing steps in order. Optionally, the reaction vessel further comprises a layer of mineral oil below one or more of the gel layers. Optionally, the reaction vessel is coupled to a heater slidable along the exterior surface of the reaction vessel for melting a gel layer adjacent the heater. Optionally, the at least one liquid aqueous reaction mixture comprises magnetic beads and the reaction vessel is coupled to a magnet slidable along an exterior surface of the reaction vessel for moving magnetic beads through a gel layer underneath the liquid aqueous reaction mixture comprising the magnetic beads. Optionally, the gel is a mixture of paraffin wax and mineral oil or silicon oil in a volumetric or weight ratio ranging from 99:1 to 25:75. Optionally, the liquid aqueous reaction mixtures contain reagents for performing ordered steps of an integrated immunoassay. Optionally, the liquid aqueous reaction mixtures contain different reagents for ordered bioprocessing steps, optionally for ordered steps in an immunoassay. Optionally, the liquid aqueous reaction mixtures each contains one or more of magnetic beads, capture antibodies, washing solution, detection antibodies, enzymes, substrate, stop solution for performing ordered steps of an integrated immunoassay. Optionally, the liquid aqueous reaction mixtures each contain one or more of lysis buffer, DNA/RNA binding solution, magnetic beads, washing buffer, and elution buffer for performing ordered steps of an integrated DNA/RNA purification. Optionally, the liquid aqueous reaction mixtures each contain one or more of a fragmentation enzyme or end repair reagent, ligation reagent, library amplification reagents for performing ordered steps of integrated NGS library preparation.

The invention further provides a method of performing a reaction, comprising providing a reaction vessel as described above, melting one of the gel layers to combine liquid aqueous reaction mixtures above and below the layer to initiate a reaction. Optionally, the reaction vessel is coupled to a heater slidable on an exterior surface of the reaction vessel and moving the heater along the surface to a position where it can melt one of the gel layers. Optionally, the heater is part of a module. Optionally, the heater is a thermoelectric device. Optionally, the thermoelectric heating element is a semiconductor-based Peltier device. Optionally, the module further comprises a cooling element for resolidifying a gel layer after melting. Optionally, the module is linked to a magnetic module for moving magnetic beads. Optionally, the magnet is an electromagnet.

The invention further provides a method of performing a reaction, comprising providing a reaction vessel as described above coupled to a slidable magnetic module on an exterior surface of the reaction vessel or interior surface of the reaction vessel, wherein at least one of the liquid aqueous reaction mixtures comprises magnetic beads and moving the slidable magnetic module along the exterior or interior surface to a position where it can move the beads. Optionally, the slidable magnetic module is linked to one of more the following modules: a mechanical module, a heat module, an electrical module, a magnetic module, an optical module to assist a reaction in the reaction vessel and detect the reaction in the reaction vessel in real time or after the reaction finished. Optionally, the reaction vessel is linked to a device for processing a sample or reagents and detecting chemical or physical changes due to a reaction in the reaction vessel, such as color, fluorescent, luminescent, chemiluminescent, electrical chemistry, radiation, reflection, phase changes, magnetic resistance, turbidity, mobility shift, pH, or ionic strength.

The invention further provides a reaction vessel containing a first layer of gel comprising a first aqueous reaction mixture and optionally a second layer of gel comprising a second aqueous reaction mixture, and optionally a third aqueous reaction mixture or samples on top of the second gel layer, the gels meltable on heating to mix the aqueous reaction mixtures. Optionally, the reaction vessel further comprises a layer of oil with a density greater than that of water above the second layer of gel.

### BRIEF DESCRIPTION OF THE FIGURES

FIG. 1: reagent-free single-layer reaction tube with pre-loaded gel layer 1. tube, 2. gel layer.

FIG. 2: reagent-free dual-layer reaction tube with pre-loaded gel layer 1. tube, 2. gel layer, 3—mineral oil.

FIG. 3: reagent containing six-layer reaction tube with pre-loaded gel and mineral oil. 1. tube, 2. gel layer, 3. mineral oil, 4. second aqueous reaction mix, 5. gel layer, 6. mineral oil, 7. first aqueous reaction mix.

FIG. 4: reagent containing three-layer reaction tube with pre-loaded gel layer. 1. tube, 2. gel layer, 3. mineral oil, 4. aqueous reaction mixture.

FIG. 5: integrated magnetic beads-based ELISA reaction vessel system that contains multi-compartmented reagents with penetrable gel layers as separating barrier and mobile external heating element and magnet piece. Arrows indicate traversing direction of the heating and magnet piece during assay.
1. Tube
2. First gel layer
3. Mobile magnet
4. Mobile heating element
5. Magnetic beads chamber
6. Magnetic beads coated with capture antibodies
7. Second gel layer
8. Washing I chamber
9. Third gel layer
10. Detection antibody-antigen binding chamber
11. Fourth gel layer
12. Washing II chamber
13. Fifth gel layer
14. Reaction product detection chamber
15. Sixth gel layer
16. Stop solution chamber

FIG. 6: integrated magnetic beads-based nucleic acids purification system that contains multi-compartment reagents with thermal sensitive gel layers and mobile external heating/cooling module and a magnetic module. Arrows indicate traversing direction of the thermal and magnetic module during purification processing.
1. Tube
2. First gel layer
3. First mobile heating/cooling element
4. Mobile magnet
5. Second mobile heating/cooling element
6. Lysis chamber
7. Second gel layer
8. Magnetic beads chamber
9. Magnetic beads
10. Third gel layer
11. Washing I chamber
12. Fourth gel layer
13. Washing II chamber
14. Fifth gel layer
15. Washing III chamber
16. Sixth gel layer
17. Elution chamber

FIG. 7: an integrated reaction vessel system that contains pre-loaded multi-compartment reagents for NGS library preparation.
1. Tube
2. First gel layer
3. Fragmentation chamber
4. First heating element
5. First heating/cooling element
6. Second gel layer
7. Ligation chamber
8. Third gel layer
9. PCR amplification chamber
10. Second heating/cooling element

FIG. 8: representative PCR amplification curves of the three reaction tubes: i) liquid format (—); ii) gel layer alone format (- - -); and iii) dual layer format with gel and mineral oil layers (—•—).

FIG. 9: photo images of the three reaction tube types before and after thermal cycling.

FIGS. 10A-C: 4-color amplification curves of the three tube formats: A) dual layer format; B) gel alone format and C) liquid format.

FIG. 11: amplification curves of the PCR reactions with the multilayer reagent

FIG. 12: photo images of the multilayer reagent tube strip before and after thermal cycling.

FIG. 13A-D: 4-Color amplification curves of the multilayer UTI reagent tubes (black) and the liquid format tubes (grey), where (A) FAM channel, (B) HEX channel, (C) ROX channel, and (D) Cy5 channel.

FIG. 14: photo images of the multilayer reagent tube strip before (top) and after (bottom) isothermal amplification at 60° C. for 90 minutes.

FIG. 15: amplification curves (FAM channel) of the reactions with the HPV31 reagent tube strip (black) and the liquid tube strip (grey).

FIGS. 16A, B: free drop experiment of the multilayer reagent tubes. 12 tube strips were allowed to free drop on lab floor from a height of about 10 feet for three times. (A) Before drop and (B) after drop.

FIGS. 17A, B: 2-color amplification curves of the two types of layer tube strip with repeated freeze/thaw cycle and long-time transport at ambient temperature (grey-FAM channel; black-ROX channel). (A) 5-layer tubes without mineral oil layer on top of the bottomed enzyme mix layer; (B) 6-layer tubes with mineral oil layer on top of the bottomed enzyme mix layer.

### DEFINITIONS

Unless defined otherwise, all technical and scientific terms have the same meaning as commonly understood in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and it is not intended to be limiting. The term “a” or “an” entity refers to one or more of that entity; for example, “a nucleic acid,” represents one or more nucleic acids. Therefore, the terms “a” (or “an”), “one or more,” and “at least one” can be used interchangeably herein.

The term “nucleic acid” encompasses any physical string of monomer units that can be corresponded to a string of nucleotides, including a polymer of nucleotides (e.g., a typical DNA or RNA polymer), peptide nucleic acid (PNA), modified oligonucleotides (e.g., oligonucleotides comprising bases that are not typical to biological RNA or DNA in solution, such as 2′-O-methylated oligonucleotides), and the like. Nucleic acids include DNA, RNA, and any combination thereof. Nucleic acids can be double-stranded or single-stranded. DNA can be genomic, cDNA, methylated DNA, or synthetic DNA, among others. RNA can be mRNA, miRNA, tRNA, rRNA, hnRNA, or methylated RNA, among others.

The four conventional nucleotide bases are A, T/U, C and G with T being present in DNA and U in RNA. The nucleotides found in targets are usually natural nucleotides (deoxyribonucleotides or ribonucleotides). Such is also the case for nucleotides forming primers.

Complementarity of nucleic acid strands means that the strands form a stabile duplex due to hydrogen bonding between their nucleobase groups. The complementary bases are in DNA, A with T and C with G, and, in RNA, C with G, and U with A. Nucleotides in respective strands are complementarity when they form one of these (Watson-Crick pairings) when the strands are maximally aligned. Nucleotides are mismatched when they do not form a complementarity pair when their respective strands are maximally aligned. Complementarity of strands can be perfect or substantial. Perfect complementarity between two strands means that the two strands can form a duplex in which every base in the duplex is bonded to a complementary base by Watson-Crick pairing. Substantial complementary means most but not necessarily all bases in strands form Watson-Crick pairs to form a stable hybrid complex in set of hybridization conditions (e.g., salt concentration and temperature). For example, some primers can duplex with a primer binding site notwithstanding up to 1, 2 or 3 positions of mismatch, provided such mismatches are not at the 3′ end and preferably not proximate thereto (e.g., within 4 nucleotides). Such conditions can be predicted by using the sequences and standard mathematical calculations to predict the Tm of hybridized strands, or by empirical determination of Tm by using routine methods. Tm refers to the temperature at which a population of hybridization complexes formed between two nucleic acid strands are 50% denatured. At a temperature below the Tm, formation of a hybridization complex is favored, whereas at a temperature above the Tm, melting or separation of the strands in the hybridization complex is favored. Tm may be estimated for a nucleic acid having a known G+C content in an aqueous 1 M NaCl solution by using, e.g., Tm=81.5+0.41 (% G+C)−675/N−% mismatch, where N=total number of bases.

Hybridization or annealing conditions include chemical components and their concentrations (e.g., salts, chelating agents, formamide) of an aqueous or organic solution containing the nucleic acids, and the temperature of the mixture in which one nucleic acid strand bonds to a second nucleic acid strand by complementary strand interactions to produce a hybridization complex.

An analyte is a molecule to be detected in a binding assay. An analyte can be an antigen, small molecule, or nucleic acid among other possibilities.

An “antigen” is a substance that, when placed in contact with a subject or organism (e.g., when present in or when detected by the subject or organism), results in a detectable immune response from the subject or organism. An antigen may be, for example, a lipid, a protein, a carbohydrate, a nucleic acid, or combinations and variations thereof. For example, an “antigenic peptide” refers to a peptide that leads to the mounting of an immune response in a subject or organism when present in or detected by the subject or organism. Antigens can thus be recognized by antigen-binding proteins such as, for example, antibodies generated by a subject or organism contacted with an antigen.

The term “epitope” refers to the portion of the antigen which is recognized by the antigen-binding protein. A single antigen (such as an antigenic polypeptide) may have more than one epitope. Epitopes may be defined as structural or functional. Functional epitopes are generally a subset of structural epitopes and are defined as those linear sequence of residues that directly contribute to the affinity of the interaction between the antigen-binding polypeptide and the antigen. Epitopes may also be conformational, that is, composed of non-linear amino acids. Epitopes may include determinants that are chemically active surface groupings of molecules such as amino acids, sugar side chains, phosphoryl groups, or sulfonyl groups, and may have specific three-dimensional structural characteristics, and/or specific charge characteristics. Epitopes formed from contiguous amino acids are typically retained on exposure to denaturing solvents, whereas epitopes formed by tertiary folding are typically lost on treatment with denaturing solvents.

A sample is a composition in which one or more analytes may be present, including patient samples, plant or animal materials, waste materials, materials for forensic analysis, environmental samples, Circulation tumor cell (CTC), cell free DNA, liquid biopsy, and the like. Samples include any tissue, cell, or extract derived from a living or dead organism which may contain a target nucleic acid, e.g., peripheral blood, bone marrow, plasma, serum, biopsy tissue including lymph nodes, respiratory tissue or exudates, gastrointestinal tissue, urine, feces, semen, or other body fluids. Samples of particular interest are tissue samples (including body fluids) from a human or animal having or suspected of having a disease or condition, particularly infection by a virus. Other samples of interest include industrial samples, such as for water testing, food testing, contamination control, and the like. Sample components may include target and non-target acids, target and non-target antigens and other analytes, and other materials such as salts, acids, bases, detergents, proteins, carbohydrates, lipids and other organic or inorganic materials. A sample may or may not be subject of processing to purify a target nucleic acid or antigen before amplification., detection or other analysis Further processing for nucleic acids can comprise treatment with a detergent or denaturant to release nucleic acids from cells or viruses, removal or inactivation of non-nucleic acid components, and concentration of nucleic acids. Further processing for polypeptide antigens can comprise any such suitable methods identified in the collection “Strategies for Protein Purification and Characterization” (updated April 2022) in Current Protocols in Protein Science 1995, Wiley, herein incorporated in its entirety by reference. Lipid, carbohydrate, or combination antigens of any of the types discussed above may be processed by any such appropriate manner as required to ensure appropriate concentration and purity for the intended assay.

A “target nucleic acid” refers to a nucleic acid molecule or population of related nucleic acid molecules that is or may be present within a sample. A target nucleic acid can include a segment to be amplified defined by primer binding sites. The segment can be the entire nucleic acid or any segment thereof of length amenable to amplification. A target nucleic acid can be an entire chromosome, gene or cDNA, and a target segment can be for example, only 40-500 of these nucleotides. A target segment can present on any strand (sense or anti-sense) of the structure. A target nucleic acid can be RNA (e.g., viral RNA, microRNA, mRNA, CRNA, rRNA, hnRNA, cfRNA, or DNA (genomic, somatic, cfDNA, cffDNA, or cDNA) among others.

The target nucleic acid can be from a pathogenic microorganism, such as a virus, bacteria or fungus, or can be endogenous to a patient. Viral nucleic acids (e.g., genomic, mRNA) form a useful target for analyses of viral sequences. Some examples of viruses that can be detected include HIV, hepatitis (A, B, or C), herpes virus (e.g., VZV, HSV-1, HAV-6, HSV-II, CMV, and Epstein Barr virus), adenovirus, XMRV, influenza virus, flaviviruses, echovirus, rhinovirus, coxsackie virus, cornovirus, corona virus, respiratory syncytial virus, mumps virus, rotavirus, measles virus, rubella virus, parvovirus, vaccinia virus, HTLV virus, dengue virus, MLV-related Virus, papillomavirus, molluscum virus, poliovirus, rabies virus, JC virus and arboviral encephalitis virus. Examples of such bacteria include chlamydia, rickettsial bacteria, mycobacteria, staphylococci, treptocci, pneumonococci, meningococci and conococci, klebsiella, proteus, serratia, pseudomonas, legionella, diphtheria, salmonella, bacilli, cholera, tetanus, botulism, anthrax, plague, leptospirosis, Lymes disease bacteria, streptococci, or neisseria. rRNA is a particularly useful target nucleic acid for typing bacteria. Detection of human or animal genes is useful for detecting presence or susceptibility to disease. Examples of genes that can be the subject of detection include cancer gene fusions, BRACA-1 or BRAC-2, p53, CFTR, cytochromes P450), for genotyping (e.g., forensic identification, paternity testing, heterozygous carrier of a gene that acts when homozygous, HLA typing), determining drug efficacy on an individual (e.g., companion diagnostics) and other uses.

The term “dNTP” generally refers to an individual or combination of deoxynucleotides containing a phosphate, sugar and organic base in the triphosphate form, that provide precursors required by a DNA polymerase for DNA synthesis. A dNTP mixture may include each of the naturally occurring deoxynucleotides (i.e., adenine (A), guanine (G), cytosine (C), uracil (U), and/or Thymine (T)). In some embodiments, each of the naturally occurring dideoxynucleotides may be replaced or supplemented with a synthetic analog, such as inosine, isoG, IsoC, deazaG, deaza A, and so forth.

A primer binding site is a complete or partial site in a target nucleic acid to which a primer hybridizes.

A primer or a probe is an oligonucleotide complementary to a primer or probe binding site contributed in whole or part by a target nucleic acid. A primer or a probe can be linked at its 5′ end to another nucleic acid (sometimes referred to as a tail), not found in or complementary to the target nucleic acid.

A primer or a probe is an oligonucleotide. The term “oligonucleotide” encompasses a singular “oligonucleotide” as well as plural “oligonucleotides,” and refers to any polymer of two or more of nucleotides, nucleosides, nucleobases or related compounds used as a reagent in the amplification methods of the present invention, as well as subsequent detection methods. The oligonucleotide may be DNA and/or RNA and/or analogs thereof and/or DNA RNA chimeric. The term oligonucleotide does not denote any particular function to the reagent, rather, it is used generically to cover all such reagents described herein. An oligonucleotide may serve various different functions, e.g., it may function as a primer if it is capable of hybridizing to a complementary strand and can further be extended in the presence of a nucleic acid polymerase, it may provide a promoter if it contains a sequence recognized by an RNA polymerase and allows for transcription, it may contain detection reagents for signal generation/amplification, and it may function to prevent hybridization or impede primer extension if appropriately situated and/or modified. Specific oligonucleotides of the present invention are described in more detail below. As used herein, an oligonucleotide can be virtually any length, limited only by its specific function in the amplification reaction or in detecting an amplification product of the amplification reaction. Oligonucleotides of a defined sequence and chemical structure may be produced by conventional techniques, such as by chemical or biochemical synthesis, and by in vitro or in vivo expression from recombinant nucleic acid molecules, e.g., bacterial or viral vectors. Oligonucleotides may be modified in any way, as long as a given modification is compatible with the desired function of a given oligonucleotide as can be easily determined. Modifications include base modifications, sugar modifications or backbone modifications. Base modifications include but are not limited to the use of the following bases in addition to adenine, cytidine, guanosine, thymine and uracil: C-5 propyne, 2-amino adenine, 5-methyl cytidine, inosine, and dP and dK bases. The sugar groups of the nucleoside subunits may be ribose, deoxyribose and analogs thereof, including, for example, ribonucleosides having a 2′-O-methyl(2′-O-ME) substitution to the ribofuranosyl moiety. See “Method for Amplifying Target Nucleic Acids Using Modified Primers,” (Becker, Majlessi, & Brentano, 2000, U.S. Pat. No. 6,130,038). Other sugar modifications include, but are not limited to 2′-amino, 2′-fluoro, (L)-alpha-threofuranosyl, and pentopuranosyl modifications. The nucleoside subunits may be joined by linkages such as phosphodiester linkages, modified linkages or by non-nucleotide moieties which do not prevent hybridization of the oligonucleotide to its complementary target nucleic acid sequence. Modified linkages include those linkages in which a standard phosphodiester linkage is replaced with a different linkage, such as a phosphorothioate linkage or a methylphosphonate linkage. The nucleobase subunits may be joined, for example, by replacing the natural deoxyribose phosphate backbone of DNA with a pseudo peptide backbone, such as a 2-aminoethylglycine backbone which couples the nucleobase subunits by means of a carboxymethyl linker to the central secondary amine. (DNA analogs having a pseudo peptide backbone are commonly referred to as “peptide nucleic acids” or “PNA” and are disclosed by Nielsen et al., “Peptide Nucleic Acids,” (Nielsen, Buchardt, Egholm, & Berg, 1996, U.S. Pat. No. 5,539,082). Other linkage modifications include, but are not limited to, morpholino bonds. Non-limiting examples of oligonucleotides or oligomers contemplated by the present invention include nucleic acid analogs containing bicyclic and tricyclic nucleoside and nucleotide analogs (LNAs). See Imanishi et al., “Bicyclonucleoside and Oligonucleotide Analogues,” (Imanishi & Obika, 2001, U.S. Pat. No. 6,268,490); and Wengel et al., “Oligonucleotide Analogues,” (Wengel & Nielsen, 2003, U.S. Pat. No. 6,670,461). Any nucleic acid analog is contemplated by the present invention provided the modified oligonucleotide can perform its intended function, e.g., hybridize to a target nucleic acid under stringent hybridization conditions or amplification conditions, or interact with a DNA or RNA polymerase, thereby initiating extension or transcription. In the case of detection probes, the modified oligonucleotides must also be capable of preferentially hybridizing to the target nucleic acid under stringent hybridization conditions. The 3′-terminus of an oligonucleotide (or other nucleic acid) can be blocked in a variety of ways using a blocking moiety, as described below. A “blocked” oligonucleotide is not efficiently extended by the addition of nucleotides to its 3′-terminus, by a DNA- or RNA-dependent DNA polymerase, to produce a complementary strand of DNA. As such, a “blocked” oligonucleotide cannot be a “primer.”

The term “degenerate primer” refers to a mixture of similar primers with differing bases at the varying positions (Mitsuhashi, J. Clin. Lab. Anal., 10(5): 285 93 (1996); von Eggeling et al., Cell. Mol. Biol., 41(5):653 70 (1995); (Zhang et al., Proc. Natl. Acad. Sci. USA, 89:5847 5851 (1992); Telenius et al., Genomics, 13(3):718 25 (1992)). Such primers can include inosine, as inosine is able to base pair with adenosine, cytosine, guanine or thymidine. Degenerate primers allow annealing to and amplification of a variety of target sequences that can be related. Degenerate primers that anneal to target DNA can function as a priming site for further amplification. A degenerate region is a region of a primer that varies, while the rest of the primer can remain the same. Degenerate primers (or regions) denote more than one primer and can be random. A random primer (or regions) denotes that the sequence is not selected, and it can be degenerate but does not have to be. In some embodiments, the 3′ target specific regions have a Tm of between about 5° C. and 50° C. In some embodiments, a 15-mer has a Tm of less than about 60° C.

A primer “3′ segment or 3′ binding region or 3′ binding site or 3′ hybridization region” is able to bind to a genomic sequence occurring in a genome at a particular frequency or other nucleic acid sequence. In some embodiments, this frequency is between about 0.01% and 2.0%, such as, between about 0.05% and 0.1% or between about 0.1% and 0.5%. In some embodiments, the length of the “binding site” of a primer depends mainly on the averaged lengths of the predicted PCR products based on bioinformatic calculations. The definition includes, without limitation, a “binding region” of between about 4 and 12 bases in length. In more particular embodiments, the length of the 3′ binding region can be, for example, between about 4 and 20 bases, or between about 8 and 15 bases. Binding regions having a Tm of between about 10° C. and 60° C. are included within the definition. The term “primer binding segment,” when used herein refers to a primer of specified sequence.

A polymerase is an enzyme that can perform template directed extension of a primer hybridized to the template. It can be a DNA polymerase, an RNA polymerase or a reverse transcriptase. Examples of DNA polymerases include: E. coli DNA polymerase I, Taq DNA polymerase, S. pneumoniae DNA polymerase I, Tfl DNA polymerase, D. radiodurans DNA polymerase I, Tth DNA polymerase, Tth XL DNA polymerase, M. tuberculosis DNA polymerase I, M. thermoautotrophicum DNA polymerase I, Herpes simplex-1 DNA polymerase, T4 DNA polymerase, thermosequenase or a wild-type or modified T7 DNA polymerase, Φ29 Polymerase, Bst Polymerase, Vent Polymerase, 9° Nm Polymerase, Klenow fragment of DNA Polymerase I. Examples of reverse transcriptase: AMV Reverse Transcriptase, MMLV Reverse Transcriptase, HIV Reverse Transcriptase. Examples of RNA polymerases include: T7 RNA polymerase or SP6 RNA polymerase, bacterial RNA polymerases and eukaryotic RNA polymerases and recombinase.

Amplification refers to either producing an additional copy or copies of all or a segment of a target nucleic acid by template-directed primer extension (target amplification) or amplifying detection signal for qualitatively/quantitatively measurement (signal amplification) or both. Amplification can be performed under temperature cycled or isothermal conditions or combined. Amplification can be linear or exponential. The target nucleic acid can be coupled to an antibody for immunoPCR or immune isothermal amplification.

The terms “thermally cycling,” “thermal cycling”, “thermal cycles” or “thermal cycle” refer to repeated cycles of temperature changes from a total denaturing temperature to an annealing (or hybridizing) temperature, to an extension temperature and back to the total denaturing temperature. The terms also refer to repeated cycles of a denaturing temperature and an extension temperature, where the annealing and extension temperatures are combined into one temperature. A totally denaturing temperature unwinds all double-stranded fragments into single strands. An annealing temperature allows a primer to hybridize or anneal to the complementary sequence of a separated strand of a nucleic acid template. The extension temperature allows the synthesis of a nascent DNA strand of the amplicon.

The term “amplification mixture” or “PCR mixture” refers to a mixture of components necessary to amplify at least one amplicon from nucleic acid templates. The mixture may comprise nucleotides (dNTPs), a thermostable polymerase, primers, and a plurality of nucleic acid templates. The mixture may further comprise a Tris buffer, a monovalent salt, and Mg²⁺. The concentration of each component is well known in the art and can be further optimized.

The terms “amplified product” or “amplicon” refer to a fragment of DNA amplified by a polymerase using a pair of primers in an amplification method such as PCR.

The term “fluorophore” refers to a moiety that absorbs light energy at a defined excitation wavelength and emits light energy at a different defined wavelength.

The term “quencher” includes any moiety that is capable of absorbing the energy of an excited fluorescent label when it is located in close proximity to the fluorescent label and is capable of dissipating that energy. A quencher can be a fluorescent quencher or a non-fluorescent quencher, which is also referred to as a dark quencher. The fluorophores listed above can play a quencher role if brought into proximity to another fluorophore, wherein either FRET quenching or contact quenching can occur. It is preferred that a dark quencher which does not emit any visible light is used. Examples of dark quenchers include, but are not limited to, DABCYL (4-(4′-dimethylaminophenylazo) benzoic acid) succinimidyl ester, diarylrhodamine carboxylic acid, succinimidyl ester (QSY-7), and 4′,5′-dinitrofluorescein carboxylic acid, succinimidyl ester (QSY-33), quencherl, or Black Hole Quencher® (BHQ-1, BHQ-2 and BHQ-3), nucleotide analogs, nucleotide G residues, nanoparticles, and gold particles.

The term “mutation” refers to one or more nucleotides in a target nucleic acid sequence that differs from a prototypical form of the target nucleic acid designated wildtype. The sequence designated wildtype is the most common allelic form of a sequence, the first discovered form of the sequence, and/or a form of the sequence associated with a normal (non-diseased phenotype). Single nucleotide polymorphisms (SNPs) are one form of mutation.

The term “surface” refers to any solid surface to which nucleic acids can be covalently attached, such as for example latex beads, dextran beads, polystyrene, polypropylene surface, polyacrylamide gel, gold surfaces, glass surfaces and silicon wafers. Preferably the solid support is a glass surface.

The term “attached to a surface” refers to any chemical or non-chemical attachment method including chemically modifiable functional groups. “Attachment” relates to immobilization of nucleic acid on solid supports by either a covalent attachment or via irreversible passive adsorption or via affinity between molecules (for example, immobilization on an avidin-coated surface by biotinylated molecules). The attachment must be of sufficient strength that it cannot be removed by washing with water or aqueous buffer under DNA-denaturing conditions.

A sticky end is a single-stranded end of a nucleic acid adjacent to a double-stranded segment of the nucleic acid. Nucleic acids with sticky ends with complementary sequences can anneal via the sticky ends and undergo ligation to one another.

A “genetic marker,” refers to a polynucleotide sequence or a modification to a polynucleotide sequence present in the genomic sequence of a reference chromosome with a known physical location that permits identification. Examples of genetic markers include but are not limited to, different alleles (e.g., alleles from two different individuals, such as alleles from a fetus v. alleles from the pregnant woman) to be distinguished from each other based on difference in the polynucleotide sequence (e.g., polymorphism), or presence or absence of the sequence at all (e.g., a sequence present on the Y chromosome from a male fetus but not present in the pregnant woman's genome). In this context, a “methylation marker” located on a chromosome relevant to the chromosomal aneuploidy refers to a genomic polynucleotide sequence on a chromosome having an abnormal number; or in the case where there is an extra piece of the chromosome or a portion of the chromosome is missing, the “methylation marker” is located within the piece or portion of the relevant chromosome. Difference in methylation profiles of the methylation marker allows distinction of the corresponding methylation marker from two different individuals, e.g., a fetus and the pregnant woman.

The term “single nucleotide polymorphism” or “SNP” refers to the polynucleotide sequence variation present at a single nucleotide residue among different alleles of the same gene, which may be the same gene located on the two copies of the same chromosome from the same individual (e.g., two alleles from a fetus) or may be the same gene from two different individuals (e.g., fetus and pregnant woman). This variation may occur within the coding region or non-coding region (e.g., the promoter region or its proximity, or the intron) of a gene, or in the intergenic region. Detection of one or more SNP allows differentiation of different alleles of a single gene.

The term “simple tandem repeat polymorphism” refers to the polynucleotide sequence variation demonstrated in the varying number of tandem repeats of a nucleotide sequence (e.g., a tandem repeat of 1 or more nucleotides) among different alleles of the same gene, which may be the same gene located on two copies of the same chromosome from the same individual (e.g., fetus) or may be the same gene from two different individuals (e.g., fetus and pregnant woman). This variation often occurs within the non-coding region (e.g., the promoter region or its proximity, or intron) of a gene, or in the intergenic region. Detection of difference in tandem repeat numbers allows differentiation of different alleles of a single gene.

The term “insertion-deletion polymorphism” refers to the polynucleotide sequence variation demonstrated in the presence or absence of a short nucleotide sequence (e.g., 1-3 nucleotides) among different alleles of the same gene, which may be the same gene located on two copies of the same chromosome from the same individual (e.g., fetus) or may be the same gene from two different individuals (e.g., fetus and pregnant woman). This variation can occur within both the coding region and the non-coding region (e.g., the promoter region or its proximity, or intron) of a gene, or in the intergenic region. Detection of whether a short nucleotide sequence is present allows differentiation of different alleles of a single gene.

The term “blood” refers to a blood sample. The term encompasses whole blood or any fractions of blood, such as serum, cell-free DNA in blood plasma, and plasma as conventionally defined. Examples of blood samples include but are not limited to, preparation from a pregnant woman or a woman being tested for possible pregnancy, a person with a disease or infection monitoring for a possible disease or infection.

The term “bisulfite” refers to all types of bisulfites, such as sodium bisulfite, that are capable of chemically converting a cytosine (C) to a uracil (U) without chemically modifying a methylated cytosine and therefore can be used to differentially modify a DNA sequence based on the methylation status of the DNA.

The term “locus” refers to a segment of DNA defined by a start nucleotide position to an end nucleotide position on a chromosome (i.e., a genomic location, or a chromosomal location) of a reference genome assembly (e.g., the Human Genome March 2006 assembly (hg18) on the UCSC Genome Browser). A locus may or may not overlap with the genomic location of a gene, a CpG island, or any product of transcription/translation. For example, a locus usually can include but is not limited to a continuous segment of DNA identified by experimental data (e.g., a MeDIP-chip dataset) and the subsequent data analysis (e.g., MAT, TAS) to contain different DNA methylation levels. A locus may contain one or more CpG sites. A locus may be sub-divided into shorter segments (e.g., CpG-containing genomic sequences, fragments or regions) that are amenable to analysis (e.g., Epityper assay, bisulfite sequencing, polynucleotide amplification and determination). A locus may be divided into one or more fetal epigenetic markers. A locus can also refer to a continuous segment of DNA identified by certain bioinformatics criteria.

The term “molecular counting” refers to any method that allows quantitative measurement of the number of a molecule or molecular complex, often the relative number in the context of other co-existing molecules or complexes of distinct characteristics. Various methods of molecular counting are described in, e.g., Leaner et al., Analytical Chemistry 69:2115-2121, 1997; Hirano and Fukami, Nucleic Acids Symposium Series No. 44:157-158, 2000; Chiu et al., Trends in Genetics 25:324-331, 2009; and U.S. Pat. No. 7,537,897.

A reaction refers to any interaction between at least two reagents. Reagents for a reaction may be present in a sample or added to a sample. The interaction can be chemical or physical in nature. Polymerase-catalyzed extension, antibody binding to an antigen, and contacting beads with a washing solution are all considered reactions.

An integrated process refers to an ordered series of steps in which product(s) of one step become starting material(s) for the next. The steps in such a process can be referred to as bioprocessing steps.

An aqueous reaction mixture includes water and at least one dissolved or suspended reagent for performing a reaction, such as a bioprocessing step, or a mixture of sample and a complete set of reaction reagents. An aqueous reaction mixture is usually liquid but can be in the form of a gel at ambient temperature changing to a liquid above ambient temperature (e.g., a reaction mixture dissolved in an agarose gel). An aqueous reaction mixture can include a complete reaction mixture meaning all reagents necessary for a sample analysis (but not necessarily the sample itself) or can be partial including at least one reaction component (in other words, a reagent) needed for performing a reaction. Two or more partial reaction mixtures can be combined to form a complete reaction mixture.

Ambient temperature means room temperature, such as 18° C. to 35° C. and more preferably 20° to 25° C., which is a range of air temperatures that most people prefer for indoor settings and is typical of laboratory environments. It feels comfortable to a person when they are wearing typical indoor clothing. Cold temperature is the presence of below room temperature, especially in the atmosphere, such as greater than 0° and below 8° C. (i.e., typical of a refrigerator or cold room). Freezing temperature is a phase transition where a liquid turns into a solid when its temperature is lowered below its freezing point such as aqueous solution below 0° C. Reagents for reactions are sometimes stored at zero to minus 20° C. or zero to minus 50° C. In accordance with the internationally established definition, freezing means the solidification phase change of a liquid or the liquid content of a substance, usually due to cooling. For most substances, the melting and freezing points are the same temperature; however, certain substances possess differing solid-liquid transition temperatures. For example, agar displays a hysteresis in its melting point and freezing point. It melts at 85° C. (185° F.) and solidifies from 32° C. to 40° C. (89.6° F. to 104° F.).

When a penetrable gel is said to be penetrable by a micropipette, it is meant that a micropipette fitted with a tip for delivering a range of volumes at an interval between 1 picoliter-5000 μL can penetrate the gel at ambient temperature when applied by hand or automated liquid handler equipment and deliver desired volume of liquid contents to beneath the gel layer stored in a reaction vessel. The penetrable gel may be interrupted by a pipette tip or an inert rod before the micropipette tip delivers liquid through the gel layer. The tip to interrupt the gel layer may or may not has a plug in it. The plug may be wax or gel. The plug tip can also be used to store reagents for any reactions inside of the tip. Some gels may be penetrable by tips for delivering volume at the lower end of the above range but not the higher end of the above range, or vice versa, whereas other gels may be penetrable by any tip within the above range. For examples, some gels are penetrable by tips of 1 μL to 1 ml or 1 μL to 500 μL or 1 μL to 100 μL.

Micropipette means a liquid handler or any device that can transfer or deliver desired volume of a liquid to a desired reaction vessel. The micropipette can carry one or multiple micropipette tips, for instance, the range from 1 to 10,000 tips. A tip is anything connected with the micropipette to deliver or transfer a liquid to a desired reaction vessel with a desired volume. The volume ranges from 1 μL to 5000 μL. The tip can be a standard industrial micropipette tip, or a one or more capillaries (e.g., a bundle of capillaries). A capillary is a hollow tube often used for delivering amounts <1 μL. A micropipette tip can deliver the liquid to above or below or into the middle of the gel layer in the reaction vessel. For a reaction vessel containing oil, the micropipette tip can deliver liquid to above or below or into the middle of the oil layer. The liquid delivered into the middle of oil or gel layer can form emulsion droplets or reaction compartments.

The invention thus further provides a method of micropipetting to deliver a reaction solution through a gel layer to an oil layer underneath the gel layer to form oil and water emulsion droplets, the number of emulsion droplets ranging from one to million. The micropipette can be a multiple channel pipette. The tip to deliver the reaction solution can be a standard industrial micropipette tips or a bundle of capillaries. The reaction volume in the emulsion droplets can range from 0.0001 μL to 5000 μL.

A module is a device performing at least one function. Multiple modules can be linked together into an integrated device performing multiple interrelated functions, e.g., a magnetic module, heating module, and a reading module and a liquid handling module. Heating and cooling can be performed by the same or different modules. Modules or integrated devices containing multiple modules can also include connectors allowing coupling of the module or device to a reaction vessel (e.g., to allow sliding along a surface of the vessel). Modules or devices including modules can include a computer or component thereof or can be adapted to receive a signal from a linked or remote computer controlling the modules or devices.

A rod means a bar or a stick, or a long thin implement made from glass, optical fiber, metal, plastics or silicon. The rod surface can be chemically modified or non-modified or partially modified. It can be conductive or non-conductive. The rod can be used to mix a solution or agitate a gel layer or as an electrode. The rod can be used to bind a target in the sample or deliver reagents or target to a reaction solution. The rod can be used as a sensor to detect chemical or physical changes in the reaction vessel. The rod can be reactive or non-reactive in an aqueous solution.

When the disclosure discloses a range of values, unless the context requires otherwise, it should be understood as providing additional disclosure of whole numbers within the range and subranges formed by whole numbers within the range.

When the disclosure discloses a composition, product or method as comprising (or including) specified components or steps, unless the context requires otherwise, it should be understood as providing additional disclosure of compositions, products or methods consisting of or consisting essentially of the specified components or steps.

### DETAILED DESCRIPTION

### I. Overview

The invention uses gel layers to cover and/or separate one or more aqueous reaction mixtures in a reaction vessel. A gel layer can protect reagents or reaction products from contacting the atmosphere thus providing an alternative to lyophilization for storage or transportation. Gel layers can also separate multiple aqueous reaction mixtures so that they do not contact one another until a gel layer is broken and the reactions mixtures contact one another. Gel layers can be penetrated by insertion of a tip from a micropipette to deliver a solution, e.g., a sample, to a reaction mixture below a gel layer. Micropipette tips or inert rods can also be used to disrupt gel layers resulting in mixing of aqueous reaction mixtures above and below a layer. Gel layers can also be broken by selective application of heat to a layer melting the gel and again resulting in mixing of aqueous reaction mixtures above and below a layer. A reaction vessel may have multiple gel layers to separate multiple aqueous reagent mixtures in which case the gel layers can be broken in a defined sequence, such as from top to bottom of the reaction vessel, to effect an ordered series of bioprocessing steps. Optionally a further oil layer can be inserted immediately underneath any or all of the gel layers.

### II. Gel Composition and Properties

A gel is a semi-solid form in which a liquid phase is entrapped within a solid-phase three-dimensional matrix. The matrix can be formed by polymerization with cross-linking and/or by self-assembly, e.g., with hydrogen bonding between particles forming the matrix. For example, a gel can be formed by heating wax and oil together such that a liquid oil phase become trapped between particles of wax. A gel can be characterized by its viscosity, usually measured in centipoise units. Viscosity is a measure of a gel's resistance to flow. The viscosity of gels is intermediate between oils and waxes. Unlike liquids, gels typically maintain their shape or stay in place in the absence of force other than gravity. In other words, a gel exhibits no flow in a steady state although the liquid phase may diffuse within the gel. Gels can conform to a shape or flow under pressure. Shape, hardness and adhesiveness (tack) of a gel is conferred by the matrix within a gel. Viscosity can be measured as the resistance of the gel to an object passing through the gel. The viscosity of the gel can be controlled by the ratio of wax to oil, which can range from 99:1 to 25-75 by weight or volume with a range from 25:75 to 75-25 or 40:60 to 60:40, 45:55 to 55:45 or about 50:50. In reaction vessels including more than one gel layer, the gel layers can have the same or different composition as each other. Gels having different composition and different melting temperatures can be used for selective melting of layers controlled by temperature.

A gel may contain other chemicals or additives. For instance, the chemicals or additives include surfactants which are chemical compounds may contain hydrophilic “heads” and hydrophobic “tails.” The “heads” of surfactants are polar and may or may not carry an electrical charge. The “tails” of most surfactants are fairly similar, including a hydrocarbon chain, which can be branched, linear, or aromatic. Fluorosurfactants have fluorocarbon chains. Siloxane surfactants have siloxane chains.

Many important surfactants include a polyether chain terminating in a highly polar anionic group. The polyether groups often comprise ethoxylated (polyethylene oxide-like) sequences inserted to increase the hydrophilic character of a surfactant. Polypropylene oxides conversely, may be inserted to increase the lipophilic character of a surfactant. Surfactant molecules have either one tail or two; those with two tails are said to be double-chained.

Surfactants are usually organic compounds that are akin to amphiphilic, which means that this molecule, being as double-agent, each contains a hydrophilic “water-seeking” group (the head), and a hydrophobic “water-avoiding” group (the tail). As a result, a surfactant contains both a water-soluble component and a water-insoluble component. Surfactants diffuse in water and get adsorbed at interfaces between air and water, or at the interface between oil and water in the case where water is mixed with oil. The water-insoluble hydrophobic group may extend out of the bulk water phase into a non-water phase such as air or oil phase, while the water-soluble head group remains bound in the water phase.

The hydrophobic tail may be either lipophilic (“oil-seeking”) or lipophobic (“oil-avoiding”) depending on its chemistry. Hydrocarbon groups are usually lipophilic, for use in soaps and detergents, while fluorocarbon groups are lipophobic, for use in repelling stains or reducing surface tension.

Waxes are a diverse class of compositions of similar composition and physical properties to bees' wax. Wax can be derived from petroleum, oil shale, animals or plants with or without modifications. Paraffin waxes include hydrocarbons, mixtures of alkanes usually in a homologous series of chain lengths from about 12-40 carbon atoms. Paraffin waxes can also include mixtures of saturated n- and iso-alkanes, naphthenes, and alkyl- and naphthene-substituted aromatic compounds. A typical alkane paraffin wax chemical composition comprises hydrocarbons with the general formula CₙH₂ₙ₊₂, such as hentriacontane, C₃₁H₆₄. Chains may or may be branched. Another type of wax is a simple lipid which is an ester of a long chain (12-32 carbon atoms). Waxes are solid at ambient temperature and melt above about 37 C. Waxes are not penetrable by a micropipette at ambient temperature without deforming or clogging the tip.

A liquid is the state with a definite volume but no fixed shape, which has a nearly incompressible fluid that conforms to the shape of its container but retains a (nearly) constant volume independent of pressure. A liquid is able to flow and take the shape of a container. Water and oil are by far the most common liquids on earth. Mineral oil is sometimes referred to simply as oil. The mineral oil or oil mentioned in this invention are interchangeable. Oils in this invention include mineral oil made from distillation of petroleum, synthetic oils, silicon oil, algal oils, and oils from plant sources, such as olive, palm, soybean, canola, corn, and peanut. Mineral oil, also called white oil, paraffin oil, liquid paraffin, paraffinum liquidum (Latin), and liquid petroleum, a liquid by-product of refining crude oil, is a transparent, colorless oil, composed mainly of alkanes and cycloalkanes, related to petroleum jelly. The oil can also be a mixture of different kinds of oils with/without surfactants in it. Surfactants added into oil mixtures facilitate the formation of emulsion droplets for digital PCR amplification or reduce the formation of emulsion droplets for qPCR detection. Different kinds of oil and mixtures thereof can have different densities, below, the same as, or above that of water.

Gels used in the invention are sufficiently viscous at ambient temperature to form a layer that can cover an aqueous mixture in a reaction vessel, prevent or at least resist dispersal of the aqueous mixture throughout the tube, and maintain itself and the aqueous reaction mixture below it in place throughout storage and transport of the tube before use, and protect the aqueous mixture from contacting the atmosphere. However, the gels described in the invention are not so viscous as to prevent a micropipette tip penetrating the gel at ambient temperature to deliver a solution, which can be a sample and/or or reagent(s) to a reaction mixture underneath the gel in a reaction vessel. The gels described in the invention preferably resist shrinkage below ambient temperature (e.g., at cold or freezing temperatures) to prevent multiple aqueous reaction mixtures separated by gel layers from being mixed during storage or transportation. Gels may melt at above ambient temperature and reform as a gel once returning to ambient temperature.

In contrast to the gels used in the invention, pure paraffin wax has the following shortcomings. It is hard to penetrate through with conventional pipette for sample addition due to clogged tip holes by invaded wax plug. It has a typical volumetric expansion of 15% when changing from solid to liquid, which can cause unwanted expansion/shrinkage effect of the barrier or cross leaking and mixing of the segregated constituent reagents in reagent vessels, as well as risk of forming hole-containing, defect layering barrier (U.S. Pat. No. 5,411,876). Additionally, if heating is used to melt the wax barrier for mixing of the segregated constituent reagents in vessels, reactions can be delayed by slow melting of the wax barrier.

Semi-solid gels offer some physical properties that can get around the shortcomings observed in pure paraffin wax as layering barrier. A gel can have a tailor-made hardness that can be penetrated through and broken apart effortlessly with pipette tips or needle like plastic pick or rod. It can have a volumetric expansion of 3%-5% or less which helps to reduce risk of uncontrolled mixing/merging of the segregated constituent reagents in reagent vessels and risk of forming hole-containing defect wax barriers during reagent vessel manufacture.

Like pure paraffin wax, which is a temperature-dependent phase change material (PCM), a gel used in this invention can change from gravitationally non-flowable semi-solid at ambient temperature, e.g., 23° C., to flowable liquid at elevated temperature, e.g., 50° C.; when vessels go back to ambient temperature, the liquified gel becomes semi-solid gel, i.e., resolidifies, which is a non-flowable matter. Because the melted semi-solid gel generally has a density lower than does mineral oil which is lighter than water or the aqueous phase, the semi-solid gel mixture floats to top of the liquid phase during heated reactions and forms a non-flowable overlay on top of the liquid content in the vessels after reaction.

### III. Layered Reaction Mixtures

Gel layers can serve multiple roles in reaction vessels. A single gel layer covering an aqueous reaction mixture can serve to hold the reaction mixture in place at the bottom of the vessel rather than dispersing throughout the vessel and form a barrier between the aqueous reaction mixture and the atmosphere protecting the reaction mixture from degradation due to interaction with the atmosphere (e.g., oxygenation or absorbing water) and/or reduce reaction products from contaminating the environment. Gel layers can be used for absorbing contaminants from a sample during a reaction reducing inhibition of the reaction by the contaminants. A gel layer can be used to controlled release components in the gel layer to the reaction mixture or absorb components from the reaction mixture.

A single gel layer covering an aqueous solution can be prepared by adding the gel to a reaction vessel with a liquid aqueous solution in it, or adding a liquid aqueous solution to a vessel already containing gel and heating the reaction vessel to melt the gel layer, which then floats above and covers the liquid aqueous solution.

An oil layer disposed between the reaction mixture and gel layer can increase protection from the atmosphere and if present is also held in place by the gel layer. The gel layer (and oil layer if present) can be penetrated by a micropipette tip to allow delivery of liquid to the aqueous layer. The liquid delivered can be one or more further reagents not already present in the aqueous reaction mixture or can be a sample to be combined with the aqueous reaction mixture, or both. Serial addition for reagents and/or sample can also be performed by multiple penetrations with a micropipette tip. Typically, the aqueous reaction mixture contains reagents for processing a sample, such as by amplification or immunoassay, and a pipette tip penetrating the gel layer is used to deliver a sample to the aqueous reaction mixture.

A gel layer can also be used to separate multiple aqueous reaction mixtures, for example, where the reaction mixtures contain different components, which are needed in combination to perform a sample assay. For example, a reaction vessel can contain 2, 3, 4, 5, 6, 7, 8, 9, 10 or more layers of aqueous reaction mixtures separated from one another by gel layers and optionally oil layers. Thus, for example, in amplification assays, polymerase(s) can be separated from primers, probes and/or dNTPs until use to reduce amplification artifacts. In immunoassays, capture and detection reagents can likewise be separated before use. In such formats, a gel layer can be used to cover a first reaction mixture and separate the first reaction mixture from a second reaction mixture, and a second gel layer used to cover the second reaction mixture. Both reaction mixtures are thus held in place in the reaction vessel and protected against atmospheric degradation. Optionally oil layers can be included between the gel layer and reaction mixture beneath it as described for a single gel layer, or between the two gel layers when the reaction vessel contains more than one aqueous solution. The same principles can be extended to further reaction mixtures and gel layers in the same vessel.

Use of multi-layered reaction mixtures involves combining the mixtures and/or delivering a further reagent and/or sample with a micropipette through a gel layer. Layers of reaction mixtures separated by gel layers can be combined by penetrating the gel layers with a rigid rod or micropipette tip and agitating the contents of the reaction vessels. Initially separate reaction mixtures combine into one layer at the bottom of the reaction vessel and initially separate gel layers combine into one layer above the combined reaction mixture. Aqueous mixtures separated by gel layers can be mixed well by centrifugation after disrupting the gel layers by micropipette tips or inert rod. A micropipette tip can also be used to deliver a reagent or sample. Such delivery can occur after segregation of multiple reaction layers and gel layers into a single reaction mixture and gel layer by penetration of the reformed gel layer. Alternatively, if a micropipette tip is used for agitation of the gel layers, a reagent or sample can be delivered as the agitation occurs. Layers of reaction mixture can also be combined by melting a gel using a heater applying heat to the gel. When the oil has density larger than that of water, the high-density oil layer in the reaction vessel can facilitate mixing of two aqueous reaction mixtures. For instance, a bottom aqueous reaction mixture is covered by a first gel layer. On top of the first gel layer is an oil mixture with density larger than that of water. On top of the oil layer is a second aqueous reaction mixture. On top of the second aqueous reaction mixture is a second gel layer. After heating the reaction vessel, the first gel layer melts, and the oil drops to the bottom of the reaction vessel pushing the first aqueous reaction mixture up to mix with the second aqueous reaction mixture. Optionally, the first aqueous mixture and the second aqueous mixture can be gels at ambient temperature in the reaction vessel. After heating the reaction vessel, both gels become fluid and are mixed due to the oil layer between them with a density higher than that of water. Layers of the reaction mixture can also be combined by moving magnetic beads present in one aqueous reaction mixture through a gel layer to another reaction mixture with a magnet outside the reaction vessel or inside the reaction vessel. Optionally, the heater or magnet used in such methods can be coupled to the reaction vessel such that the heater or magnet can slide along an exterior or interior surface of the reaction vessel until it is adjacent to a gel layer to be melted by the heater or disrupted by movement of magnetic beads induced by the magnet. Optionally, a reaction vessel can be coupled to a device includes both heater and magnetic modules. Gel layers can be removable after reactions have occurred.

Alternatively, or additionally gel layers can have different compositions and melting temperatures, such that layers can be disrupted in a defined order according to their melting temperature by controlling the temperature of the whole reaction vessel (e.g., by immersion in a heated bath).

A device including a reader can be used to assist or facilitate processing a sample liquid handling of reagents and detection reactions occurring in a reaction vessel. When all reactions are prepared, reaction vessels are placed in an appropriate reader (e.g., thermocycler for traditional PCR or real-time PCR or hot block/water bath for isothermal amplification) to complete and monitor the reaction. A device including a reader module can also include a combination of one or more than one of the following modules: a mechanical module, a heat module, an electrical module, a magnetic module, a liquid handling module, and an optical module to assist the reactions in the reaction vessel and detect the reaction in the reaction vessel in real time or after the reaction has finished. The reader can detect the chemical or physical changes of the reactions in the reaction vessel, such as color, fluorescent, luminescent, chemiluminescent, electrical chemistry, radiation, reflection, phase changes, magnetic resistance, turbidity, mobility shift, pH, or ionic strength.

Reaction vessels including multiple layers of aqueous reagents separated by gel layers can be used for performing integrated bioprocesses that involve a series of ordered steps. Steps can be affected by selective disruption of gel layers so that only aqueous reaction mixtures above and below a gel layer are mixed at one time. After mixing, a reaction between reagents in the mixtures occurs and one or more products of the reaction then become starting material(s) to be combined with another aqueous reaction mixture by disrupting a further gel layer. Product(s) of this further reaction can then be combined with a still further aqueous reaction mixture by disrupting a further gel layer. Typically gel layers are disrupted successively moving downward, with the possible exception of the top gel layer, which may be left in place to provide continued separation of reagents and products of reactions from the atmosphere. Gel layers can be disrupted with a micropipette tip, which can also be used to introduce a sample or other reagent, with an inert rod, by melting of the gel layer by selective application of heat to that layer, or by movement of magnetic beads present in an aqueous layer across a gel layer induced by a magnet, or any combination of these techniques.

Other reaction vessels include layers of aqueous reaction mixtures, gel, and optionally oil in a random order among the vessels.

Reaction vessels can be fitted with a device comprising modules for heating/cooling and/or applying a magnetic field, the device slidable along the outer surface of the vessel to permit directed application of heat or cooling to a particular gel layer, or application of a magnetic field to magnetic beads in a particular aqueous reaction mixture. The heater can be a thermoelectric device, such as a semiconductor-based Peltier device. The magnet can be an electromagnet.

### IV. Reaction Vessel Formats

A reaction vessel serves to hold a gel and contain a reaction mixture or any component thereof. Examples include microtubes of various sizes from microliters to milliliters commonly used in laboratories. Reaction vessels may or may not have lids, such as snaps, screws, cling-film or metal foil, and may or may not be suitable for use with microcentrifuges. Reaction vessels may be single-use or reusable. Reaction vessel can be a channel or trench or hollow tube or include a flat surface. Reaction vessels can be individual vessels or interconnected as strips or matrixes of vessels to facilitate parallel processing. Reaction vessels can also be in the form of multi-well plates (e.g., 96, 384, or 1536 wells) or tips or chips in which case each well of such a plate or chip can be considered to be a reaction vessel and wells in the chip can be connected through channels.

Depending on the desired application, reaction vessels may be plastic (e.g., polypropylene), glass, metal, or any other material suitable for the intended reaction (e.g., impervious, or inert to the intended aqueous reaction mixture, gel, and oil contents of the vessel). Reaction vessels may have inherent hydrophobic or hydrophilic properties depending on their material composition, or they can be treated to achieve the desired hydrophobicity/hydrophilicity for the intended reaction.

Vessels suitable for performing PCR include single PCR tubes, PCR tube strips, and/or PCR plates, or cartridge, among others that can perform reactions for one or more samples simultaneously. Reaction vessels for ELISA assays include commercially available ELISA plates, deep well plates, and/or microtiter plates, and/or cartridge among others that can perform reactions for one or more samples simultaneously.

Reaction vessels are sealed during storage or transportation. Reaction vessels can be sealed by a film, such as aluminum foil and then stored at heat sealing metallic storage pouch. Reaction vessels can be shipped at ambient temperature or in a Styrofoam box with blue ice or dry ice. Reaction vessels can be stored at desired temperatures.

### V. Reactions Compatible with the Reaction Vessel

Gel layers can be used to cover a solution before, during or after a reaction. Gel layers can be used to separate reaction mixtures for a large variety of reactions including various chemical reactions, immunoassays, nucleic acid detection assays, sequencing and/or purification protocols. Any assay method that contains multiple aqueous reaction mixtures maintained separately until the assay is performed can be adapted to the disclosed strategies, including the use of greater or lesser numbers of reaction layers than those presented in the representative examples and figures.

Gel layers can be used to inhibit interactions among reagents before the desired reaction happens, for instance, non-specific amplification or primer dimer for nucleic amplification. Gels layers can be used for sequential reactions such as reverse transcription reaction (RT) above the gel layer and then mixing the PCR reagents with the RT products for amplification and detection. Another example is a nicking amplification can be performed about the gel layer first and then the gel layer is melted for PCR reaction. Another application is nested PCR. The first stage amplification can be performed above the gel layer. The second stage amplification can be performed after the gel is melted. In summary, multistage amplification, such as NASBA, T7, CRISPR, RPA, EXPAR can be sequentially processed in different gel layers. Another example is a reaction vessel that contains a solution underneath of a gel layer. The solution contains proteinase K. A sample is added to the reaction vessel and the reaction vessel is heated at 95° C. for 10 minutes. The treated sample can be used for other reactions, or the PCR reagents can be added to the reaction vessel for amplification and detection.

Another example is for immune PCR or immune isothermal amplification. Immuno reactions happen above the gel layer from proximity interaction and then mix with another reagents for PCR or isothermal amplification to detect the analyte.

### 1. Amplifications Reactions:

Amplification reactions are used for detecting target nucleic acids, genetic markers, single nucleotide polymorphisms, insertions, deletions, insertions, inversions, rearrangements, transversions, deletions, indels, microsatellite repeats, minisatellite repeats, short tandem repeats, transposable elements, large scale structural chromosomal variants, methylation, and combinations thereof. Amplifications are also used in nucleic acid cloning protocols and in sequencing among other applications.

Many well-known methods of nucleic acid target amplification require thermocycling to alternately denature double-stranded nucleic acids and hybridize primers;

however, other well-known methods of nucleic acid amplification are isothermal. The polymerase chain reaction, commonly referred to as PCR (Mullis, 1987 U.S. Pat. No. 4,683,202; Saiki et al., 1985, Science (New York, N.Y.), 230(4732), 1350-1354), uses multiple cycles of denaturation, annealing of primer pairs to opposite strands, and primer extension to exponentially increase copy numbers of the target sequence. In a variation called RT-PCR, reverse transcriptase (RT) is used to make a complementary DNA (cDNA) from mRNA, and the cDNA is then amplified by PCR to produce multiple copies of DNA (Gelfand et al., “Reverse Transcription with Thermostable DNA Polymerases—High Temperature Reverse Transcription,” (Gelfand, 1994, U.S. Pat. Nos. 5,322,770; Gelfand & Myers, 1994, U.S. Pat. Nos. 5,310,652). Another method of amplifying nucleic acid is called the LCR method (ligase chain reaction, Laffler, Carrino, & Marshall, 1993, Annales De Biologie Clinique, 51(9), 821-826). LCR (Laffler et al., 1993, Annales De Biologie Clinique, 51 (9), 821-826) is based on the reaction in which two adjacent probes are hybridized with a target sequence and ligated to each other by a ligase. The two probes could not be ligated in the absence of the target nucleotide sequence, and thus the presence of the ligated product is indicative of the target nucleotide sequence. The LCR method also requires control of temperature for separation of a complementary chain from a template. Another method is strand displacement amplification (George T. Walker, Little, & Nadeau, 1993, U.S. Pat. No. 5,270,184; George T. Walker, 1995, U.S. Pat. No. 5,455,166; G. T. Walker et al., 1992, Nucleic Acids Research, 20(7), 1691-1696, 1992, Proceedings of the National Academy of Sciences of the United States of America, 89(1), 392-396), commonly referred to as SDA, which uses cycles of annealing pairs of primer sequences to opposite strands of a target sequence, primer extension in the presence of a dNTP to produce a duplex hemiphosphorothioated primer extension product, endonuclease-mediated nicking of a hemimodified restriction endonuclease recognition site, and polymerase-mediated primer extension from the 3′ end of the nick to displace an existing strand and produce a strand for the next round of primer annealing, nicking and strand displacement, resulting in geometric amplification of product. Thermophilic SDA (tSDA) uses thermophilic endonucleases and polymerases at higher temperatures in essentially the same method (Fraiser, Spargo, Van, Walker, & Wright, 2002, European Pat. No. 0 684 315). Other amplification methods include: nucleic acid sequence based amplification (Compton, 1991, Nature, 350(6313), 91-92, Malek, Davey, Henderson, & Sooknanan, 1992), commonly referred to as NASBA; one that uses an RNA replicase to amplify the probe molecule itself (Lizardi, Guerra, Lomeli, Tussie-Luna, & Russell Kramer, 1988, Nature Biotechnology, 6(10), 1197-1202), commonly referred to as Qβ replicase; a transcription-based amplification method (Kwoh et al., 1989, Proceedings of the National Academy of Sciences of the United States of America, 86(4), 1173-1177); self-sustained sequence replication (3SR), (Guatelli et al., 1990, Proceedings of the National Academy of Sciences of the United States of America, 87(5), 1874-1878; Landgren (1993) Trends in Genetics 9, 199-202; and Lee, H. et al., NUCLEIC ACID AMPLIFICATION TECHNOLOGIES (1997)); and, transcription-mediated amplification (Kwoh et al., 1989, Proceedings of the National Academy of Sciences of the United States of America, 86(4), 1173-1177; Kacian & Fultz, 1995, U.S. Pat. No. 5,480,784; Kacian & Fultz, 1996, U.S. Pat. No. 5,399,491), commonly referred to as TMA. For further discussion of known amplification methods see Persing, David H., 1993, “In Vitro Nucleic Acid Amplification Techniques” in Diagnostic Medical Microbiology: Principles and Applications (Persing et al., Eds.), pp. 51-87 (American Society for Microbiology, Washington, D.C.). Other illustrative amplification methods suitable for use in accordance with the present invention also include rolling circle amplification (RCA) (Fire & Xu, 1995, Proceedings of the National Academy of Sciences, 92(10), 4641-4645; Lizardi, 1998, U.S. Pat. No. 5,854,033); Nucleic Acid Amplification Using Nicking Agents (Van Ness, Galas, & Van Ness, 2006, U.S. Pat. No. 7,112,423); Nicking and Extension Amplification Reaction (NEAR) (Maples et al., 2009, US 2009-0017453 A1); Helicase Dependent Amplification (HDA) (Kong, Vincent, & Xu, 2004, US 2004-0058378 A1; Kong, Vincent, & Xu, 2007 US pat. US2007/0254304 A1); and Loop-Mediated Isothermal Amplification (LAMP) (Notomi & Hase, 2002, U.S. Pat. No. 6,410,278), and Quadruplex priming amplification (Analyst, 2014, 139, 1644-1652). Expar amplification (PNAS Apr. 15, 2003, 100, 4504-4509). Cross priming amplification (Sci Rep. 2012; 2:246). SMAP amplification (Nature Methods 04/2007; 4(3):257-62). Multiple displacement amplification (MDA, Proceedings of the National Academy of Sciences 2005, 102(48): 17332-6.), Recombinase Polymerase Amplification (RPA) (Journal of Clinical Virology 54(4): 308-12). Single primer isothermal amplification (SPIA) (clinical chemistry, 2005 vol. 51 no. 10 1973-1981), hybridization chain reaction (HCR) (Chem Soc Rev. 2017 Jul. 17; 46(14):4281-4298).

Primers and probes used in the above methods can be limited composition primers in which at least one of the four standard nucleotide types is present at no more than two internal positions and/or the 5′ end as described in WO2019/033065 and WO2016172632.

Another aspect of amplification is signal amplification. When a sufficient amount of nucleic acids to be detected is available, there are advantages to detecting that sequence directly, instead of making more copies of that target, (e.g., as in PCR and LCR). Traditional methods of direct detection including Northern and Southern blotting and RNase protection assays usually require the use of radioactivity and are not amenable to automation. Other techniques have sought to eliminate the use of radioactivity and/or improve the sensitivity in automatable formats. The cycling probe reaction (CPR) (Duck, Alvarado-Urbina, Burdick, & Collier, 1990b, BioTechniques, 9(2), 142-148), uses a long chimeric oligonucleotide in which a central portion is made of RNA while the two termini are made of DNA. Hybridization of the probe to a target DNA and exposure to a thermostable RNase H causes the RNA portion to be digested. This destabilizes the remaining DNA portions of the duplex, releasing the remainder of the probe from the target DNA and allowing another probe molecule to repeat the process. Branched DNA (bDNA), described by Urdea et al., 1987, Gene, 61(3), 253-264, involves oligonucleotides with branched structures that allow each individual oligonucleotide to carry 35 to 40 labels (e.g., alkaline phosphatase enzymes). While this enhances the signal from a hybridization event, signal from non-specific binding is similarly increased. Other signal amplification methods include: Invasive Cleavage of Nucleic Acids (Prudent, Hall, Lyamichev, Brow, & Dahlberg, 2006, U.S. Pat. No. 7,011,944); Hybridization Chain Reaction (HCR) (R. M. Dirks & Pierce, 2004, Proceedings of the National Academy of Sciences of the United States of America, 101(43), 15275-15278, R. Dirks & Pierce, 2012, U.S. Pat. No. 8,105,778) and G-quadruplex DNAzyme-based colorimetric detection. CHA amplification (J. Am. Chem. Soc., 2013, 135(20), pp 7430-7433). SMART signal amplification (Biotechniques 2002 March; 32(3):604-6, 608-11.)

Amplification products can be detected qualitatively (i.e., positive signal relative to control) or quantitatively (signal intensity related to absolute amount or relative amount of analyte giving rise to amplification product). Detection can include but does not require further analysis, such as sequencing of an amplification product. The methods provided by the invention may also include directly detecting a particular nucleic acid in a capture reaction product or amplification reaction product, such as a particular target amplicon or set of amplicons. Accordingly, mixtures of the invention can comprise specialized probe sets including TAQMAN™, which uses a hydrolyzable probe containing detectable reporter and quencher moieties, which can be released by a DNA polymerase with 5′->3′ exonuclease activity (Livak, Flood, & Marmaro, 1996, U.S. Pat. No. 5,538,848); molecular beacon, which uses a hairpin probe with reporter and quenching moieties at opposite termini (Tyagi, Kramer, & Lizardi, 1999, U.S. Pat. No. 5,925,517); Fluorescence resonance energy transfer (FRET) primers, which use a pair of adjacent primers with fluorescent donor and acceptor moieties, respectively (Wittwer, Ririe, & Rasmussen, 2001, U.S. Pat. No. 6,174,670); and LIGHTUP™, a single short probe which fluoresces only when bound to the target (Kubista & Svanvik, 2001, U.S. Pat. No. 6,329,144). Similarly, SCORPION™ (Whitcombe, Theaker, Gibson, & Little, 2001, U.S. Pat. No. 6,326,145) and SIMPLEPROBES™ (Wittwer et al., 2003, U.S. Pat. No. 6,635,427) use single reporter/dye probes. Amplicon-detecting probes can be designed according to the particular detection modality used, and as discussed in the above-referenced patents. Other detection methods include gel electrophoresis, mass spectrometry, or capillary electrophoresis, melting curve, nucleic acid-based fluorescent chelating dye such as SYBR™ green, or detection of amplification products using a fluorescent label and a soluble quencher (Will, Gupta, & Geyer, 2014, U.S. Pat. No. 8,658,366).

The term “multiplex amplification” refers to the amplification of more than one nucleic acid of interest. For example, it can refer to the amplification of multiple sequences from the same sample or the amplification of one of several sequences in a sample as discussed, for example, in George T. Walker, Nadeau, & Little, 1995 U.S. Pat. Nos. 5,422,252; and George T. Walker, Nadeau, Spears, et al., 1995, U.S. Pat. Nos. 5,470,723, which provide examples of multiplex strand displacement amplification. The term also refers to the amplification of one or more sequences present in multiple samples either simultaneously or in stepwise fashion.

The term “digital polymerase chain reaction” or “dPCR” refers to a refined version of conventional polymerase chain reaction (PCR) methods used to directly quantify and clonally amplify nucleic acids including DNA, cDNA or RNA, such that the amount of target nucleic acid can be directly quantitatively measured. Digital PCR achieves this direct quantitative measurement by partitioning individual target nucleic acid molecules present in a sample into multiple aliquots within many separate reaction chambers that are able to localize and concentrate the amplification product to detectable levels. Preferably, the sample is partitioned such that most aliquots (e.g., at least 50%, 75%, 90%, 95% or 99%) receive zero or one molecule of each target nucleic acid to be detected. When a reaction vessel contains oil underneath a gel layer, a micropipette can deliver a desired volume of reaction mixture(s) to the oil layer to form a desired number of oil water emulsion droplets. The reaction volume varies from picoliters to microliters. The number of emulsion droplets varies from one to a million. The micropipette is a multichannel pipette. The tip to deliver the reaction mixtures can be a bundle of capillaries. Optionally the reaction mixtures can be directly delivered to the gel layer to form multiple reaction compartments. The gel will be warmed to a desired temperature to start the reaction in the compartments. After PCR amplification, the presence of a signal in any droplet or compartment is an indication the target nucleic is present and a count of droplets or compartments containing the PCR end-product is a direct measure of the absolute target nucleic acid quantity. The capture or isolation of individual nucleic acid molecules, typically by way of dilution, may be effected in capillaries, microemulsions, arrays of miniaturized chambers, or on nucleic acid binding surfaces. The basic methodology of digital PCR is described in, e.g., Sykes et al., Biotechniques 13 (3): 444-449, 1992; and Vogelstein and Kinzler, PNAS 1999; 96:9236-41. Other forms of amplification described herein, such as transcription mediated amplification, can analogously be performed digitally. The method of the digital PCR method described in this invention can also be applied for immunoassays using nucleic acid tags (digital immunoassay, such as described in the U.S. Pat. No. 9,896,717), or other assays for absolutely quantifying a target in a sample or multiple targets in a sample to be analyzed.

The term “real-time amplification” refers to an amplification reaction for which the amount of reaction product, i.e., amplicon, is monitored as the reaction proceeds. Forms of real-time amplification differ mainly in the detection mechanisms used for monitoring the reaction products. Detection methods are reviewed in Mackay, Arden, & Nitsche, 2002, Nucleic Acids Research, 30(6), 1292-1305, which is incorporated herein by reference.

The term “detection label” refers to any atom or molecule which can be used to provide or aid to provide, a detectable (preferably quantifiable) signal, and can be attached to a nucleic acid or protein. Labels may provide signals detectable by fluorescence, radioactivity, colorimetry, gravimetry, magnetism, enzymatic activity and the like. Detection labels can be incorporated in a variety of ways: (1) the primers comprise the label(s), for example, attached to the base, a ribose, a phosphate, or analogous structures in a nucleic acid analog; (2) nucleotides triphosphates are modified at either the base or the ribose (or to analogous structures in a nucleic acid analog) with the label(s); the label-modified nucleotides are then incorporated into a newly synthesized strand by an extension enzyme such as a polymerase; (3) modified nucleotides are used that comprise a functional group that can be used (post-enzymatic reaction) to add a detectable label; (4) modified primers are used that comprise a functional group that can be used to add a detectable label in a similar manner; (5) a label probe that is directly labeled and hybridizes to a portion of the amplicon can be used; (6) a label that can be incorporated into amplified products; (7) a label that can react with byproducts of amplification reaction.

The techniques, devices, and methods described herein offer improvements over prior arts in providing reaction vessels. For instance, traditionally PCR strips or plates or immune assay ELISA plates sold as empty wells. This invention provides reaction vessels with micropipette penetrable pre-loaded gel layers in them, optionally including oil underneath the gel layer. The pre-loaded gel reaction vessel enables to pre-load partial or complete reaction mixtures in the reaction vessel with improved shelf-life of reagent and prevention of laboratory environment against carryover contamination. As such, the reaction vessels are configured to contain preloaded reaction mixtures, are segregated using gel layers in the vessels. After sample addition, the reactions can start underneath a gel layer to prevent the reaction mixture from contacting the atmosphere. Thermally induced reactions result in a temperature above ambient and consequent change of the gel from semi-solid to lighter-than-water liquid and migration of the liquified gel to top of the liquid phase of the reaction mixture. When the reaction run is complete, the reaction vessels cool to the ambient temperature leading to solidification of the gel and formation of a non-flowable barrier overlay on top the aqueous reaction, thus preventing the amplification product from leaking and contaminating the laboratory environment due to imperfect sealing or mishandling of the post-reaction vessels.

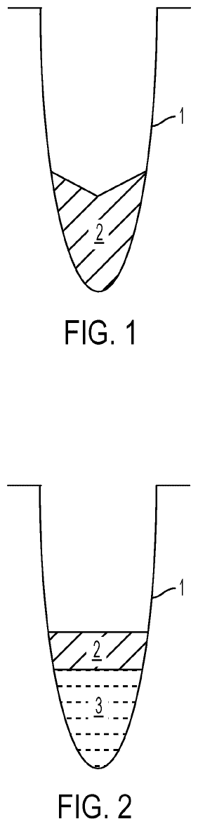

Referring to FIG. 1 as an embodiment, a reagent-free reaction tube is configured to contain a preloaded gel layer. After adding e.g., 20 μL reaction master mix and e.g., 5 μL samples into the reaction tube, during first thermal cycle of a PCR reaction, the e.g., 25 μL of reaction mixture will fall through the gel layer and settle at bottom of the tube due to difference in density between the melted gel layer and the aqueous phase, as well as the surface tension of the gel layer surface. In this embodiment, gel layer with lower melting point, aqueous phase containing salts, and larger volume ratio of gel layer to aqueous phase are favorable for facilitating the added aqueous layer sinks to the bottom of the tube during first thermal cycle of a PCR reaction or the earliest time possible of an isothermal reaction. The melted gel layer cools and solidifies forming a solid barrier on top of the liquid content in the tubes after reaction.

When only a gel layer is used, the equal volume of aqueous layer may not sink to bottom of the tube or even below the level of the melted gel layer during a PCR run. To ensure that the aqueous layer sinks below the melted gel layer during PCR run, 2:1 or larger volume ratio of gel layer to aqueous layer, e.g., 40 μL:20 μL can be used. Nevertheless, as the volume ratio increases, the added reaction mix is kept further away from the bottom of the tube before PCR run, causing prolonged heat transfer between the heat source and the reaction mix and eventually delayed amplification reactions. Additionally, more gel present in the tube will take longer time to melt resulting in retarded reactions. Therefore, pure wax preloaded gel reaction tubes can result in compromised performance in reaction kinetics or delayed Ct. FIG. 2 shows a modification configured to contain certain amount of mineral oil underneath the gel layer. To use this dual layer reaction tube, a user first disrupts the gel layer using a micropipette tip or a needle like plastic pick, and then adds constituent reagents (e.g., 20 μl) and/or sample (5 μl) via the hole opening of the disrupted gel layer. To mimic the heat transfer condition of a conventional liquid PCR where constituent reagents and sample are located at bottom of the reaction tube before first thermal cycle of an amplification cycle, a centrifugation of the mineral oil-containing and sample added tubes with a microfuge device helps to bring the aqueous phase down to bottom of the tube before reaction. Like the embodiment shown in FIG. 1, the dual layer reaction tubes result in a non-flowable gel overlay on top of the tubes after reaction.

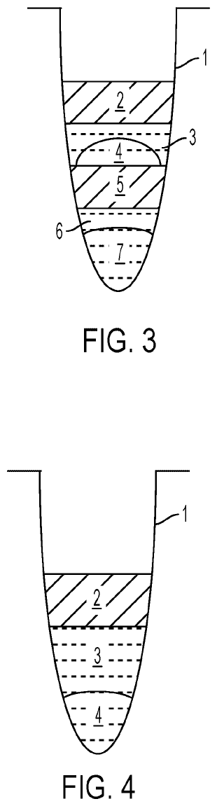

Although embodiments shown in FIG. 1 and FIG. 2 provide reaction tubes capable of universally accommodating any reagents for contamination-protected PCR or isothermal amplification or any biochemical reactions, reaction tubes involved less reagent preparation and pipetting operation, or provided in the manner of “just-add-sample,” are desirable for user who wants to reduce human procedural error, expedite assay results, and improve lab work efficiency. The embodiment shown in FIG. 3 is configured to contain complete constituent reagents or complementary subsets of reagent in a reaction vessel where complementary subsets of reagent are segregated in isolated compartments using mineral oil and a gel layer. Pre-mixing of subsets of PCR reagents or isothermal amplification reagents at ambient temperature prior to thermal cycling or constant heating is undesirable as it can retard the reactions by depletion of primers resulting in non-specific primer dimer or other by-products and delay of yielding target products or reduce performance. In this multilayer configuration, one subset of a PCR or isothermal reagents in volume of e.g., 10 μL is loaded at bottom of an e.g., 0.1 ml tube which can be either a primer mix or an enzyme mix, followed by certain amount of mineral oil, certain amount of gel layer mixture, another certain amount of mineral oil, e.g., 10 μL of complementary subset of reagent, and another certain amount of a gel layer mixture, sequentially.

To use this embodiment for PCR or isothermal reactions, as in the procedure described in embodiment shown in FIG. 2, a user first disrupts the two gel layers using a pipette tip or a needle like plastic pick, and then adds e.g., 5 μL of sample through the disrupted gel layers. To facilitate complete capture of small volume of sample, e.g., 1.0 μL, in the liquid phase of the reagent tubes, additional mineral oil layer is loaded between the two gel layers. Lastly, a brief centrifuge action is applied to the capped and sample added tubes with a microfuge, which collects all the aqueous components down to the bottom of the tubes for most efficient thermal reactions during the first thermal cycle of the PCR reaction or isothermal amplification. The top gel layer serves to keep the liquid content from flowing to all the places on the inner wall of the reagent tubes during product manufacture, storage, transport and or assay handling. Like the embodiment shown in FIG. 2, the six-layer reaction vessel results in a non-flowable gel layer on top of the reaction vessel after or during the reaction.

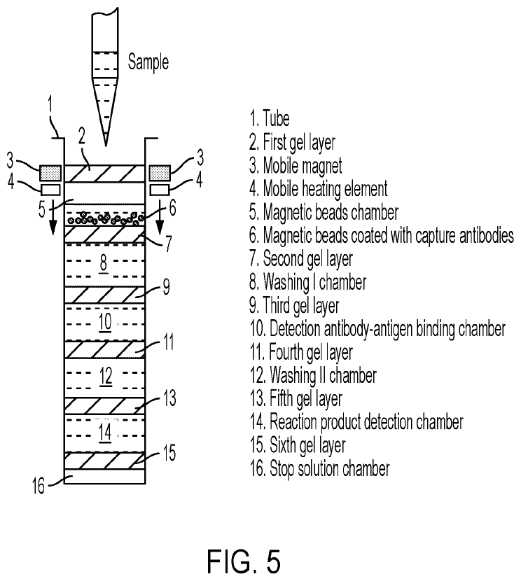

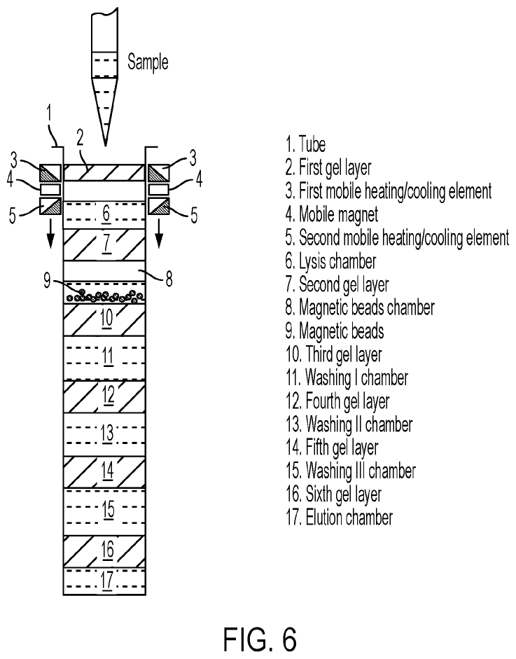

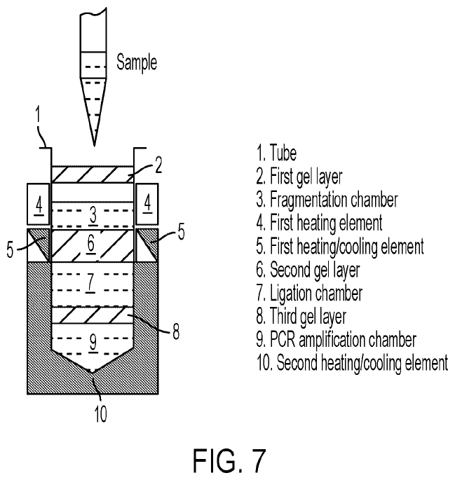

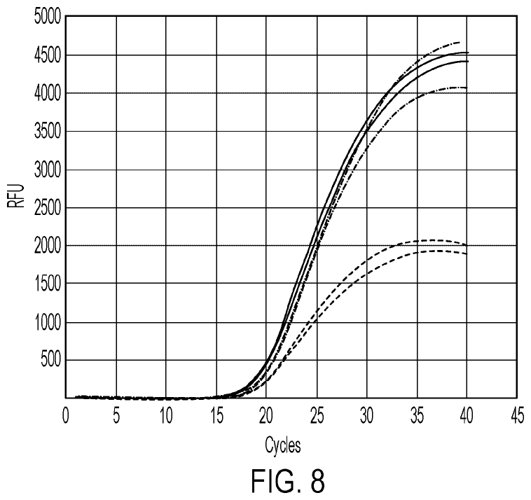

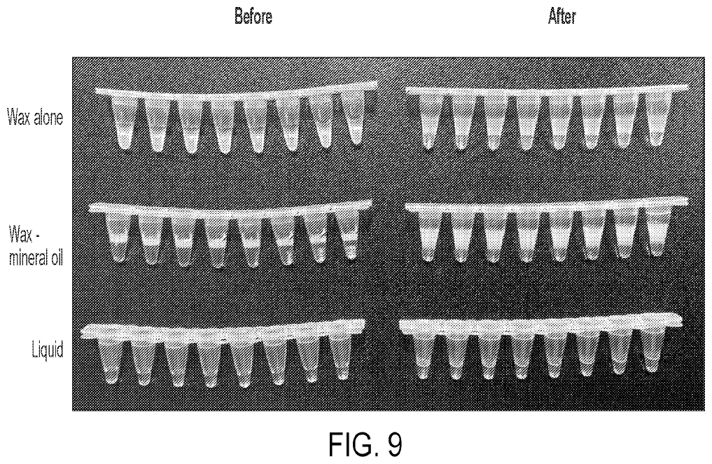

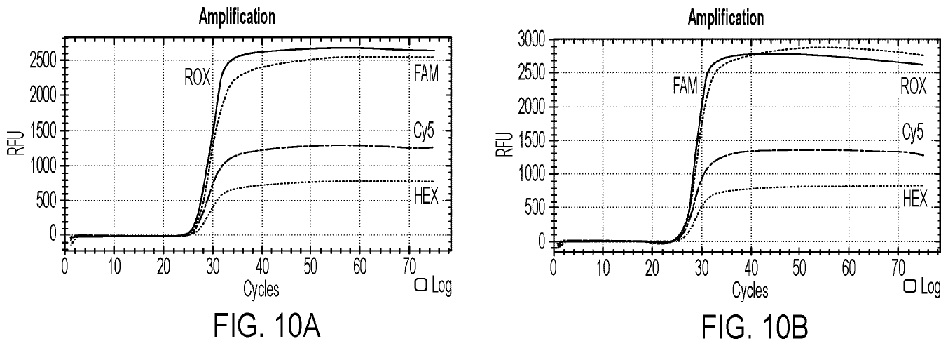

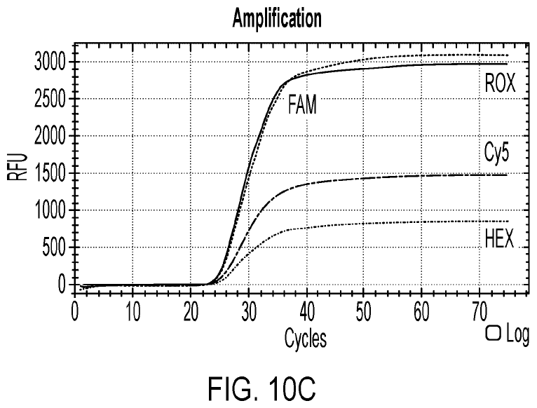

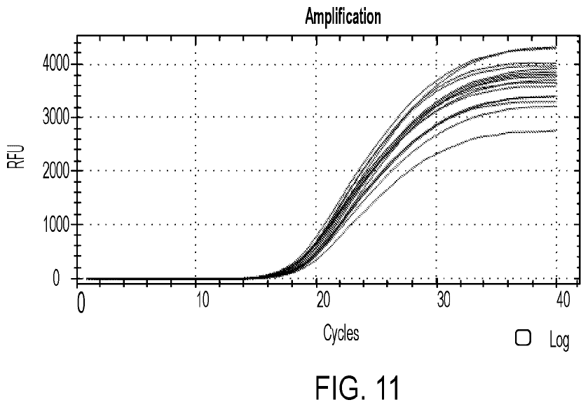

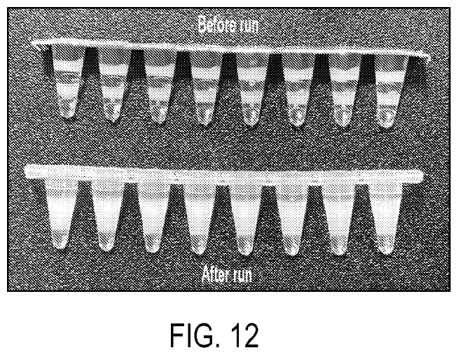

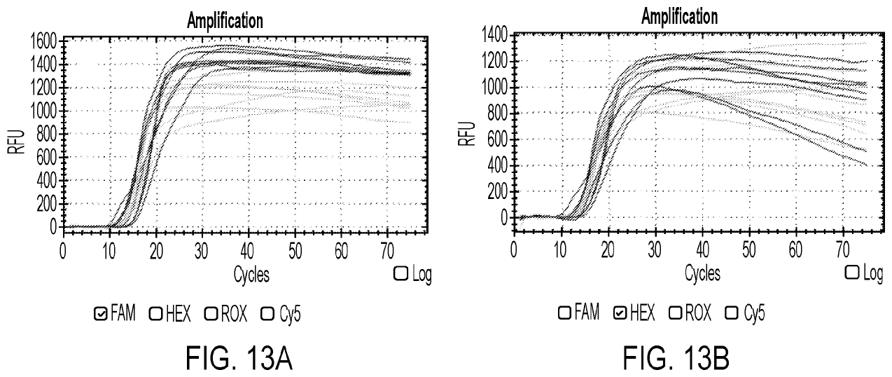

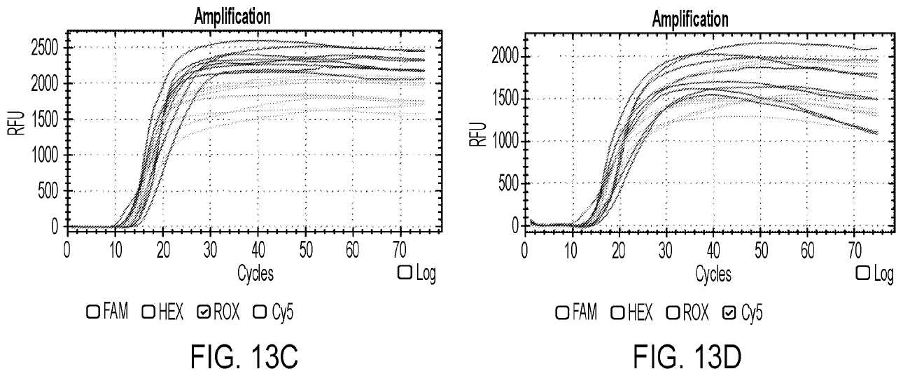

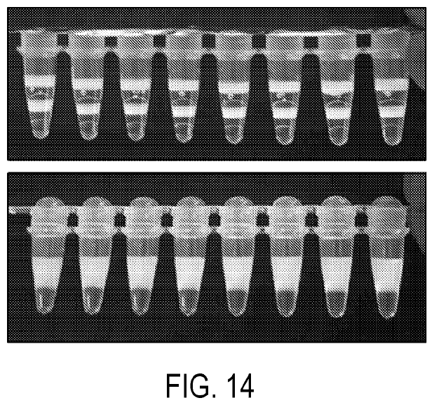

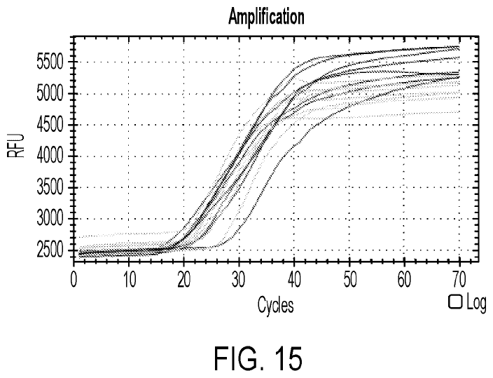

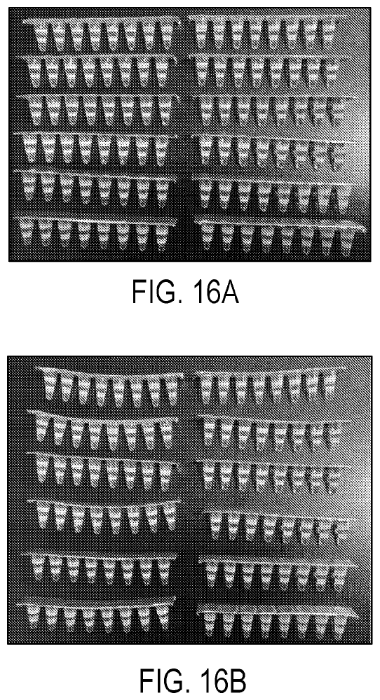

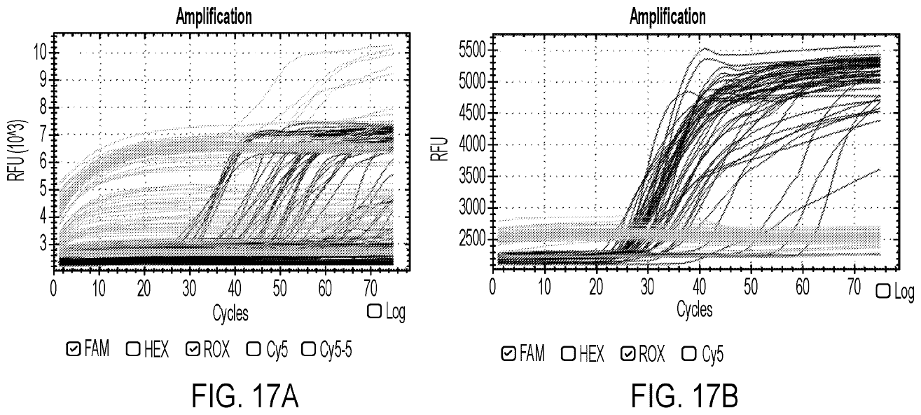

In an embodiment as shown in FIG. 4, the reaction tube is configured to contain only one subset of the constituent reagents which is overlaid by one layer of mineral oil followed by one layer of gel on top. This embodiment is advantageous over the multi-subset reagent containing embodiment when assay procedure is performed in a rural open area that is exposed to a temperature that is above ambient temperature, e.g., 40° C., for a prolonged time, e.g., several hours or longer. Consequently, the gel layer may melt to liquify at the high temperature. However, the melting of the layer does not have an adverse effect on performance of the preloaded constituent reagent in the tube as it is thermally stable at temperatures well below its chemical degradation temperature.

### 2. Nucleic Acid Detection Assays

Target nucleic acids or one or more loci within them can be detected using various binding assays involving nucleic acid primers and probes. For example, a target nucleic acid can be detected with an oligonucleotide immobilized to a support. A target nucleic acid can also be detected with a capture probe in solution, which binds to a target nucleic acid and to an immobilized probe. In either format, a labelled detection probe can be used to detect bound target nucleic acid. Target nucleic acids can also be detected by primers with a target-specific extension or single-base extension assays. Nucleic acids can also be analyzed by various sequencing methods including Sanger dideoxy synthesis and Maxam-Gilbert chemical cleavage and new methods such as 454 pyrosequencing is one example of a sequencing method (Siqueira et al., J Oral Microbiol. 2012; :10.3402/jom.v4i0.10743. doi:10.3402/jom.v4i0.10743), Ion Torrent (see Hu et al., Human Immunology 82, 801-811(2021) and Illumina bridge amplification sequencing (see, e g., Slatko et al., Curr. Protoc. Mol. Biol. 122(1), e59 (2018)). Nucleic acids can also be analyzed by bisulfite sequencing and similar techniques for epigenic analysis, and molecular counting.

### 3. Immunoassays

Immunoassays are bioanalytical methods in which the quantitation of the analyte depends on the reaction of analyte and an antibody (see generally Darwish, Int J Biomed Sci. 2006 September; 2(3): 217-235). These reagents are the antibodies, signal-generating labels, including to use nucleic oligos to generate detectable signals such as PCR methods (immunoPCR), sequencing (NGS, next generation sequencing) or immuno isothermal amplification and separation matrices. The nucleic oligos generate detectable signal can be proximity reactions. The antibodies can be either polyclonal or monoclonal. Immunoassay methods can be applied for analysis of a single analyte, or multiple analytes in parallel (e.g., at least 1, 5, 10, 20 or 100) two or even more analytes in the same sample, employing different approaches.

The signal generating labels in immunoassays include radioactive atoms (mostly 125I, 3H, and 14C). The use of radioactive labels offers extremely sensitive and quite precise assays; however, they have drawbacks (e.g., health hazards, special attention for handling of the reagents, training of staff, short half-life time of the isotope, and expensive instrumentation for the counting of radioactivity. Therefore, alternative non-radioactive labels such as enzymes, fluorescent probes, chemiluminescent substances, metals and metal chelates, and liposomes have been introduced. Enzyme labels allow amplification of the signal, and consequently, a potential increase in the sensitivity of the method.

The matrices used for separation of the immune complexes that formed as a result of immunoanalytical reactions include charcoal, polyethylene glycol, second antibody, microbeads, including magnetic beads, or multiwell plates in which one component of a reaction analyte or antibody is coated onto the surface of the bottom of the plate wells, and the immune complex is formed on the surface of the wells. The use of these plates facilitates the washing steps, and reagents pipetting, and thus facilitates automation.

In an exemplary radioimmunoassay a known quantity of a target is made radioactive, frequently by labeling it with gamma-radioactive isotopes of iodine, such as 125-I, or tritium attached to tyrosine. This radiolabeled target is then mixed with a known amount of antibody for that target, and as a result, the two specifically bind to one another. Then, a sample containing an unknown quantity of that same target is added. The unlabeled target from the sample competes with the radiolabeled antigen for antibody binding sites. As the concentration of unlabeled target is increased, more of it binds to the antibody, displacing the radiolabeled variant, and reducing the ratio of antibody-bound radiolabeled target to free radiolabeled target. The bound targets are then separated and the radioactivity of the free (unbound) target remaining in the supernatant is measured using a gamma counter.

Enzyme immunoassay (EIA) is analogous to RIA except that the label is an enzyme rather than a radioisotope. The basic approach for use of an enzyme as an immunoassay label is appreciated by coupling an enzyme molecule into one of the immunoanalytical reagents (analyte or antibody), by appropriate chemical technique, and then carrying out the immunoanalytical reaction in the normal way. Following the separation of bound and free fractions, the enzyme activity is monitored in either of the two fractions. This is achieved by adding substrate, and subsequent monitoring the turnover of the substrate to product. The product must possess measurable physical or chemical differences from the substrate. For example, colorless chromogenic substrates which are converted into colored products by the action of the enzyme label. The colored products can be simply measured by a spectrophotometer. The measured signal is then correlated to the analyte concentration.

Enzyme-linked immunosorbent assay (ELISA) is a method for detecting and quantifying a specific protein in a complex mixture (Hayrapetyan et al. Methods Mol. Biol 2612:1-17 (2023)). The method enables analysis of protein samples immobilized on a solid support (e.g., magnetic beads) using specific antibodies. ELISAs can be performed in 96-well or 384-well polystyrene plates, which passively bind antibodies and proteins to magnetic beads. Having the reactants of the ELISA immobilized to magnetic beads facilitates separation of bound from non-bound material during the assay.

Various forms of ELISA typically include four basic elements: (1) coating/capture-direct or indirect immobilization of antigens to the surface of a solid support (e.g., a well of a multi-well plate, paper, spherical beads, or rod, as detailed below); (2) blocking-addition of irrelevant protein or other molecule to cover all unsaturated surface-binding sites of the reaction vessel; (3) probing/detection-incubation with antigen-specific antibodies that affinity-bind to the antigen of interest; and (4) signal measurement-detection of the signal generated via the direct- or secondary-conjugated enzyme on the affinity-bound antibody, as described in greater detail below.

ELISA involves multiple rounds of binding and washing to ensure specific binding. Separation of reagents for every step with gel in a horizontal and/or vertical chamber enables stepwise reactions to happen without the hassle of liquid handling. Beads coated with proteins can pass through layers of reagents separated with gel for washing and binding before the final detection stage.

ELISA can be performed through different formats mainly plate-based, chip-based, bead-based, paper-based (PVDF, nitrocellulose, cellulose), or rod-based. The general concept of performing ELISA on these platforms is mostly similar to the conventional immunoassays as mentioned earlier. Plate-based, chip-based, bead-based and/or rod-based ELISA can be performed by automation for high-throughput screening while paper-based ELISA is mainly served for point-of-care testing. The rod-based ELISA is performed with analyte-binding molecules anchored on the bottom tip of a disposable rod. The rod can be a glass rod, optical fiber, plastic, metal rod, capillary, electrode, magnetic bar with/without a cover. The rod can be applied in combination with a cartridge for conducting automated, high-throughput immunoassay tests, with the capability of detecting multiple analytes for numerous samples the same time, or on the other hand, can be applied in combination with a cartridge for conducting automated, point-of-care immune assay tests. Optionally the rod is made by conductive magnetic materials used as both capturing analytes for real time detection by measuring magnetic sensor or magnetoresistance as described in the patent of US20130274131 and/or an electrode for ECL reaction. The real time detection can be performed based on the rod using a magnetic sensor (US20130274131). In such case, for example, a detection antibody is coated with magnetic beads LABELS. Attachment of beads to the rod causes rod magnetic resistance changes (magnetic sensor). Alternatively, the rod can be used in combination with a magnetic beads-based immunoassay or nucleic acid signal amplification assay such as HCR. The rod can assist in moving the beads through different gel layers or reaction chambers and also be used as electrode for ECL reactions. A cartridge is a reaction cuvette that comprise diffusely bound and non-diffusely bound reagents for carrying out an immunoassay, whereby separation of the reagents is realized by penetrable gel in this invention. A cartridge assembly tray can be used to secure multiple test cartridges and rods into an assembly to be applied to an immunoassay apparatus for conducting the high-throughput test.

Magnetic beads with different surface chemistries including Ni²⁺, sulfo-SMCC, tosyl, carboxyl group are intended to immobilize proteins or antibodies or molecules of interest for ELISA. The beads serve as platform for immobilization of molecules to initiate ELISA followed by the subsequent steps of washing and binding by moving beads through gel layers. Bead-based ELISA allows handling of high-throughput samples with automation reducing the turnover time. gel chambers separating the washing solution and binding molecules, respectively allows beads-based ELISA to perform in one-pot format. Guiding the magnetic beads through different chambers or gel layers for specific reaction allows continuous reaction to happen without the repetitive action of liquid handling.

Subtypes of ELISA can also be categorized as direct, indirect, and sandwich. After immobilization of the antigen of interest, by either direct adsorption to the assay beads or indirectly via a capture antibody that has been attached to the beads, an analyte is then detected either directly (labeled primary antibody) or indirectly, such as labeled secondary antibody specific for the primary antibody or a biotin-streptavidin complex for amplification. Specificity of a secondary antibody for the primary antibody can be achieved using capture and primary antibodies from different host species (e.g., mouse IgG and rabbit IgG, respectively). For sandwich assays, it is beneficial to use secondary antibodies that have been cross adsorbed to remove any secondary antibodies that might have affinity for the capture antibody. In sandwich ELISA, the analyte to be measured is bound between two primary antibodies, each detecting a different epitope of the antigen—the capture antibody and the detection antibody. The most commonly used enzyme labels are horseradish peroxidase (HRP) and alkaline phosphatase (AP) or ECL immune assay as described In the Journal of Electroanalytical Chemistry Vol. 919, 15 Aug. 2022, 116511) Other enzymes that can be used include β-galactosidase, acetylcholinesterase, and catalase. A large selection of substrates is available commercially for performing ELISA with an HRP or AP conjugate. The choice of substrate depends on the required assay sensitivity and the instrumentation available for signal-detection (spectrophotometer, fluorometer, or luminometer).

FIG. 5 illustrates a preferred embodiment of the present invention for performing efficient integrated immunoassay with a reaction vessel that contains pre-sealed or pre-preloaded reagents. In this embodiment, a penetrable gel layer mixture is used as a compartmentation barrier to segregate all the individual reagents in a manner that is in line with a typical magnetic beads-based ELISA assay workflow for determination of a target antigen. To facilitate transporting the magnetic beads through each of the gel layers in the vessel, a heating element is attached to the front side of an external magnet piece which can be configured as a 2-in-1 module. When the assay proceeds to traversing the beads through a gel layer, the heating element is engaged and positioned to the target a gel layer where it warms up the gel layer helping to lower viscosity of the barrier, and thus, allowing transport of the beads from chamber to chamber or layer to layer. To further facilitate such a traversing action through one or more gel layers, paired or multiple magnet pieces can be introduced reducing the number of beads per magnet and consequently increasing the magnetic force on the beads.

Fabrication of such a reaction vessel involves similar manufacture procedures that are described in the section of the amplification reaction vessels of the present invention. Briefly, to an e.g., 1.5 or 2.0 mL plastic vessel with an inner diameter of e.g., 5.0 mm are added the following reagents and gel layers, sequentially from bottom to top of the vessel: e.g., 100 μL of stop solution, 20 μL of gel layer, 100 μL of substrate solution, 20 μL of gel layer, second washing buffer, 20 μL of gel layer, 100 μL detection antibody solution, 20 μL of gel layer, 100 μL first washing buffer, 20 μL of gel layer, 50 μL solution containing magnetic beads coated with capture antibody, 20 μL of layer. After cooling, the vessel is capped with a foil seal. Optionally, e.g., 10-20 μL mineral oil is added to each of the aqueous layers for enhanced segregation of the reagent components. Optionally, a reaction vessel contains two layers of aqueous reaction mixtures separated by gel layers. The bottom aqueous reaction mixtures contain signal amplification elements, such as substrates for HRP, AP or ECL. The top aqueous reaction mixtures contain magnetic beads coded with capture antibody and labeled detection antibody. After adding the samples to the top aqueous solution with incubation at certain temperature, the beads can be moved through the first gel layer to the first aqueous reaction mixtures that contains enzymatic substrates or ECL substrates to generate chemiluminescence or color reactions.

In use, the foil seal is peeled off from the vessel, followed by poking through the top gel layer with an inert rod. Then, e.g., 100 μl of sample is added to the liquid phase of the beads chamber. To speed up the immuno-binding reactions, a device including thermal and magnetic modules is engaged to resuspend and mix the magnetic beads in the sample solution by alternating on and off action of the electromagnetic field of magnet pieces. Then, a heating element is positioned at the second gel layer followed by brief heating thereon and moving the actuated magnetic module forward which drags the beads penetrating/passing through the gel layer and entering the first washing chamber. Next, the magnet module is positioned to a central section of the target chamber and a programmed electromagnetic mixing is followed for effective washing of the beads. By following these similar operation procedures, the beads enter the detection chamber where they develop detectable color with the enzymatic reactions therein. Optionally to control the time-dependent color intensity of the detection chamber, a heating module linked to the magnet module is positioned to the bottom gel layer and heated up to melt and liquify the gel layer. As a result, the colored reaction mixture falls through the liquified gel layer and merges with a stop solution underneath which allows end-point quantitation of the target antigen with a stable color of the reaction mixture. The intensity of the color observed or measured in the merged reaction mixture is proportional to the levels of the antigen molecules present in the sample.

### 4. Integrated Bioprocessing

Reaction vessels can be used for integrated sequential reactions.

For instance, DNA/RNA purification is the process of isolating and extracting DNA or RNA from biological samples, such as blood, tissues, cells, or microbial cultures. The purification process involves the removal of impurities and contaminants that may affect the quality and integrity of the genetic material.

There are various types of impurities or contaminants that can be present in a DNA or RNA sample, depending on the source and the processing steps involved. Biological and environmental samples generally contain PCR inhibitors, which significantly hinder the activity of DNA polymerases and reduce the sensitivity and efficiency of a PCR reaction.

DNA polymerases vary in their tolerance of PCR inhibitors. For example, DNA polymerases widely used in real-time and quantitative PCR, such as Taq polymerase, are completely inactive in the presence of small amounts of blood (0.004% to 0.2%). The problem of PCR inhibition originating from DNA samples can be solved in various ways, particularly by sample dilution and sample purification. Nevertheless, this inhibition can still be a concern with many PCR-based human blood tests, since even after purifying DNA from the blood, traces of the PCR inhibitors can generate high false negative rates. Another example is agriculture related microorganisms, infectious disease pathogens, and bioterrorism related pathogens tests in soil samples. Direct extraction of total DNA from soil samples results in a co-extraction of humic acid, known as the most potent soil inhibitor to PCR analysis. Humic substances represent a mixture of partially characterized polyphenols that are produced during the decomposition of organic matter. Other inhibitory components include fulvic acid, polysaccharides and metal ions that can be present in varying concentrations in the soil samples.

Some of the most common impurities or contaminants include:

Proteins: Proteins can co-purify with DNA or RNA and can interfere with downstream applications such as PCR, sequencing, and gene expression analysis.

Salts: High salt concentrations can affect the quality of the DNA or RNA sample and can inhibit enzymatic reactions such as PCR.

Organic solvents: Organic solvents such as phenol or chloroform, which are often used in DNA/RNA extraction protocols, can co-purify with DNA or RNA and can affect downstream applications.

Residual cellular debris: Cellular debris such as lipids, polysaccharides, and other macromolecules can co-purify with DNA or RNA and can affect the quality and quantity of the sample.

Nucleases: Nucleases are enzymes that can degrade DNA or RNA and can be present in the sample or introduced during processing.

Contaminants from the environment: Contaminants such as dust, aerosols, or other microorganisms can enter the sample during collection or processing and can affect the quality of the DNA or RNA.

Removing these impurities or contaminants from the DNA or RNA sample ensures accuracy and reliability of downstream applications. The purified DNA or RNA can be used for various downstream applications such as PCR, sequencing, cloning, gene expression analysis, and more.

There are several methods for DNA/RNA purification, and the choice of method depends on the type of sample and the downstream application. Here are some common DNA/RNA purification methods:
1) Organic solvents extraction: This method involves the use of organic solvents, such as
Phenol-Chloroform, β-mercaptoethanol and polyvinylpolypyrrolidone (PVPP-40), Chloroform-isoamyl alcohol, isopropanol and salt, and TRIZOL™.
Nucleic acids can also be treated by proteinase K, underneath a gel layers for example at 95° C. for ten minutes.
2) Centrifugation
3) Phase Separation: After centrifugation, the sample separates into three distinct layers: an aqueous phase containing the nucleic acids, a lower organic phase containing the denatured proteins, and a middle interphase containing other contaminants.
4) Precipitation: The nucleic acids are then precipitated with ethanol or isopropanol, washed with a wash buffer, and then dissolved in a buffer for further analysis.

The present invention can be applied for organic solvents extraction by pre-allocating all needed reagents in one vessel: e.g., from the top to bottom, the layers are a gel layer 1, lysis solution, gel layer 2, organic solvents, gel layer 3, void, ethanol, gel layer 4, elution buffer. In use, first add the sample on top of gel layer 1. After melting of gel layer 1, the sample is mixed with the lysis solution. After lysing, gel layer 2 is melted, and sample is mixed with the organic solvents. After vertexing and centrifuge, gel layer 3 blocks the organic phase and only allows liquid phase containing nucleic acid to go through. The resultant nucleic acid is then precipitated by ethanol layer. After centrifuging, the precipitated nucleic acid goes through gel layer 4 while the ethanol layer is blocked resulting in purified nucleic acid in the bottom elution buffer layer. This embodiment of the invention can also be combined with other layers as mentioned elsewhere in this application. Such formats can include all reagents in one vessel protecting the user from being exposed to toxic reagents. This all-in-one design also makes the whole procedure easier and simpler, which can be further adapted to automated instruments.

Column-based purification and size selective purification: This method involves the use of columns filled with resin or membrane or silica spin column that selectively binds to DNA or RNA. The sample is loaded onto the column, and the nucleic acids are captured while the impurities pass through. After washing the column, the purified DNA or RNA is eluted with a buffer. DNA size selective purification is a process that allows for the isolation of DNA fragments of a specific size range from a mixture of DNA fragments.

This technique is commonly used in molecular biology experiments that require specific DNA fragment sizes, such as cloning, PCR, and sequencing. One of the most used methods is column-based purification. DNA fragments can be separated by size using a size exclusion column, which separates DNA fragments based on their size and charge.

After loading the sample onto the column, the DNA fragments of interest can be eluted using an appropriate buffer.

The present invention can be applied for column-based DNA separation by pre-allocating all needed reagents in one vessel: e.g., from the top to bottom, the layers are gel layer 1, gel layer 2, gel layer 3 . . . ending with a void. Different layers of gel have different binding affinity to DNA/RNA and different melting point due to different wax to oil ratios. Thus, different layers will bind DNA/RNA with different size range. In use, the sample is added on the top of gel layer 1. Then, the tube is centrifuged until all liquid phases go through the gel layer and reach the bottom void area. DNA/RNA are taken out by melting specific gel layers followed by pipette transfer. For example, the targeted DNA/RNA is bound in gel layer 2. Gel layer 1 is first melted and removed with a pipette. Then gel layer 2 is melted and transferred to a clean tube with the DNA/RNA being contained in the gel layer. This embodiment of the invention can also be combined with other gel layer formats described elsewhere in the application. An advantage of this embodiment is that it includes all the reagents in one vessel. This all-in-one design makes the whole procedure easier and simplified, which can be further adapted to automated instruments.

Magnetic bead-based purification: This method involves the use of magnetic beads coated with a ligand that selectively binds to DNA or RNA. The ligand includes for example —OH, —SH, —NH2 and —COOH. When the sample is mixed with the beads, the DNA or RNA binds to the magnetic beads which are captured by a magnetic field. After washing, the purified DNA or RNA is eluted. This technique can also be used to isolate and purify DNA fragments of a specific size range from a mixture of DNA fragments using magnetic beads. This method is commonly used in molecular biology experiments that require specific DNA fragment sizes, such as cloning, PCR, and sequencing. The basic steps for magnetic bead-based purification are as follows:
(a) Lysis: The sample is first lysed to release the nucleic acids from the cells or tissues. The lysis buffer typically contains detergents, which help to break down the cell membrane and release nucleic acids. Lysing reagents include for example sodium dodecyl sulfate (SDS), Triton X-100, guanidine thiocyanate or chloride salt, proteinase K or other protease that degrades proteins, lysozyme, and combinations thereof.
(b) Binding the DNA to magnetic beads: The magnetic beads are added to the sample containing the DNA fragments of interest, and the beads are mixed to allow the DNA to bind to the beads. The binding reagent includes but not limited to water, Tris-HCl buffer, PBS buffer, ethanol, isopropanol, propanol, butanol, or other water miscible alcohol, DMSO, THF, NaCl or other salts.
(c) Washing the beads: The beads are washed to remove any contaminants or unbound DNA fragments. The washing reagent can include for example, water, Tris-HCl buffer, PBS buffer, ethanol, isopropanol, propanol, butanol, or other water miscible alcohol, DMSO, THF, NaCl or other salts, and any combination thereof.
(d) Eluting the DNA: The DNA fragments of interest are eluted from the beads using an appropriate buffer or solvent. The elution reagents include for example water, Tris-HCl buffer, PBS buffer, NaCl or other salts, and any combination thereof.

Some advantages of magnetic bead-based purification include high yield and purity of DNA fragments; rapid and efficient purification; easy to automate and scale up for high-throughput applications. However, there are also some potential disadvantages of magnetic bead-based purification include: higher cost compared to other purification methods; limited size range of DNA fragments that can be purified using some types of magnetic beads; possibility of non-specific binding of DNA fragments to the magnetic beads, leading to loss of some DNA fragments.

The present invention can be applied to magnetic beads-based DNA or RNA separation by pre-allocating all needed reagents in one vessel. FIG. 6 is a preferred embodiment which is an integrated magnetic beads-based DNA/RNA purification system. Configuration wise, the reaction vessels of this integrated purification system are like those described in the section of the integrated immunoassay system. However, since most of the commercially available magnetic bead kits entail heated lysis and elution procedure at elevated temperatures (e.g., 50-60° C.) for improved yield and purity, prevention of collapse of the thermally sensitive gel layers during purification processing is a challenge. Hence, cooling of the gel layers that are directly contacted to the lysis chamber or elution chamber is incorporated when configurating this integrated vessel system. Manipulation of the heating and cooling of the vessel section is realized using e.g., a Peltier device which can function as a thermoelectric cooler or a thermoelectric generator, depending on polarity of a DC current being applied to the device. In addition, a thicker gel layer interfacing these two chambers can be employed to reduce the risk of the gel layer failure during processing.

To use the vessel shown in FIG. 6, a user peels off a foil seal on top the vessel (not shown) and disrupts the top gel layer using an inert rod or pipette tip. Then the user pipette-transfers e.g., 100-200 μL of raw sample to the lysis chamber which contains e.g., 100 μL of lysis buffer. After re-sealing the vessel opening with a lid, a heating and cooling module is engaged to contact to the wall section of the lysis chamber, with the heating element wrapping onto the liquid section of the chamber for lysis with a cooling element on a downstream gel layer for barrier protection. The lysis process occurs at e.g., 50-60° C. whereas the barrier cooling is at e.g., 15-20° C. After e.g., 5-10 minutes of lysis, operation of the module is changed to heating mode from cooling mode by switching polarity of the applied DC power supply. As a result, the affected gel layer is heated up and partially melted as a result of which the lysis solution falls through the gel layer and merges with DNA/RNA binding solution and magnetic beads in the beads chamber. To mix the aqueous solution with the beads thoroughly in the beads chamber, an electromagnet pair is allowed to actuate in an alternating on-and-off manner for e.g., 5-10 minutes. Then, the heating element is positioned to the next gel layer, followed by a brief warm up exerted therein which softens the gel barrier allowing the beads to penetrate and traverse through it with less resistance. Penetration and traversing of the beads through the warmed gel layer is driven by moving the external actuated electromagnet downstream. After the beads enter the first washing chamber, the electromagnet pair is positioned to center section of the washing chamber where actuation of the electromagnet pair is initiated and operated in an alternating on-and-off manner for e.g., 1-2 minutes. This washing step will wash off most of the impurities carried on the beads. Repeat this washing procedure for the next two washing steps in the subsequent washing chambers, each step taking about e.g., 1-2 minutes to complete. Lastly, the washed beads are transported to the elution chamber for heated elution processing by heating and electromagnetic modules. Again, to protect the upper gel layer from collapse during heating of the elution chamber at e.g., 50-60° C., one pair of the thermoelectric coolers are positioned to this upper gel layer and a cooling condition (e.g., 10-20° C.) is maintained until the elution is complete. When the elution is complete which takes about e.g., 3-5 minutes, the beads are moved back to the third washing chamber leaving a neat eluant solution containing purified DNA/RNA for subsequent processing or reactions, e.g., integrated downstream amplification.

### 5. Reaction Vessels for Integrated NGS Library Preparation

Next-generation sequencing (NGS) is a technology that allows for the rapid and accurate sequencing of entire genomes or targeted regions of DNA or RNA. NGS utilizes massively parallel sequencing, meaning that many sequences can be read at the same time, making the process much faster and more efficient than traditional sequencing methods. DNA libraries are prepared from biological samples and serve as the starting material for sequencing. Library preparation typically involves several steps:

### DNA Fragmentation:

NGS library preparation begins with DNA fragmentation. This step breaks the long DNA strands into smaller fragments that can be sequenced. There are two main methods for DNA fragmentation: enzymatic fragmentation and mechanical fragmentation. Enzymatic fragmentation involves using restriction enzymes or other enzymes to cut the DNA into smaller pieces, and certain enzymatic methods do not require end repair of the fragmented DNA. Mechanical fragmentation, on the other hand, uses physical forces like sonication or Covaris shearing to break the DNA strands.

### End Repair:

After fragmentation, the DNA fragments are often subjected to an end repair step. This step involves adding nucleotides to the ends of the fragments to repair any damage that may have occurred during the fragmentation process. The repaired ends of the DNA are essential for adapter ligation and subsequent PCR amplification.

### Adapter Ligation:

The next step in NGS library preparation is adapter ligation. Adapters are small, synthetic DNA sequences that are added to the ends of the DNA fragments to enable them to bind to the sequencing platform. Adapters can be ligated to the DNA using a variety of methods, including T4 DNA ligase, which catalyzes the formation of phosphodiester bonds between the adapter and the DNA fragment.

### PCR Amplification:

Once the adapters have been ligated to the DNA fragments, the library undergoes PCR amplification. PCR amplification is used to create millions of copies of the DNA fragments so that there is enough material for sequencing. PCR can also introduce biases or errors, so it is important to optimize the reaction conditions to minimize these effects.

### Bead Clean-Up:

The final step in NGS library preparation is bead clean-up. This step removes any unligated adapters, adapter dimers, or other impurities from the library. Bead cleanup involves using magnetic beads that bind to the DNA fragments and allow the unwanted material to be washed away. Once the DNA fragments are purified, the library is ready for sequencing.

Commercial kits are available that streamline the library preparation process and eliminate the need for certain steps, such as post-ligation bead cleanup. Enzymatic steps, such as enzymatic fragmentation, can be accomplished using heat-labile enzymes, which can be inactivated by a mild heat treatment. Mechanically sheared DNA requires end repair to ensure that the DNA ends are compatible with adapter ligation. Overall, NGS has revolutionized the field of genomics and has enabled rapid and accurate sequencing of complex genomes, leading to breakthroughs in fields such as medicine, agriculture, and environmental science.

The invention provides a new approach to NGS library preparation by utilizing a reaction vessel that contains three aqueous reagent layers separated by three gel layers as shown in FIG. 7. This reaction vessel design enables the complete NGS library preparation process to be carried out in a single vessel, eliminating the need for multiple tubes or plates, and reducing the risk of contamination or loss of material.

Referring to FIG. 7, the first layer of aqueous reagents contains the enzymatic fragmentation reagents or end repair reagents, which are for breaking the DNA into smaller fragments and repair any damage that may have occurred during fragmentation. The enzymes used in this layer of aqueous reagents are heat labile, meaning that they can be inactivated by mild heat treatment, which allows for easy removal of the enzymes prior to the next step. The second layer of aqueous reagents contains the adapter ligation reagents, which are for attaching the adapters to the ends of the DNA fragments. This layer of reagents is separated from the first layer by a gel layer, which prevents mixing of the two layers. The third layer of aqueous reagents contains the library amplification reagents, for providing enough of the DNA fragments for sequencing. This layer is separated from the second layer by another gel layer.

Overall, this reaction vessel design provides a convenient and efficient way to perform NGS library preparation, allowing for the entire process to be completed in a single vessel. The use of gel layers helps to prevent mixing of the different reagent layers. This approach has the potential to simplify the library preparation process and improve the reproducibility and reliability of NGS results.

In some embodiments, intact DNA is added into the first layer of aqueous reagents containing the enzymatic fragmentation reagents through a micropipette tip that penetrates the top gel layer. This method ensures that the DNA is evenly dispersed throughout the first layer of reagents. The reaction vessel is then incubated at e.g., 25° C. for 30 minutes, during which time the enzymatic fragmentation reagents break the DNA into smaller fragments. Once the enzymatic fragmentation step is complete, the reaction vessel is incubated at e.g., 50° C. for 10 minutes to inactivate the heat-labile enzymes. This step ensures that the enzymes are no longer active and do not interfere with subsequent steps while maintaining the integrity of the second and third gel layers.

The second layer of gel is then disrupted using a micropipette tip, allowing the fragmented DNA to mix with the adapter ligation reagents in the second layer of aqueous reagents. The reaction vessel is then incubated at e.g., 25° C. for 30 minutes to allow the adapters to ligate to the DNA fragments. After the adapter ligation step is complete, the third layer of gel is disrupted using a micropipette tip, allowing the ligation product to mix with the library amplification reagents in the third layer of aqueous reagents. Finally, the reaction vessel is incubated through a PCR program to amplify the library, producing enough DNA fragments for sequencing.

Mechanically sheared DNA refers to DNA that has been fragmented using mechanical means, such as sonication or shearing by force, rather than enzymatic fragmentation. In this embodiment, the DNA is added into the first layer of aqueous reagents containing the end repair reagents through a micropipette tip that penetrates the top gel layer. The end repair reagents are then allowed to act on the DNA at e.g., 25° C. for 30 minutes. After this, the heat-labile enzymes are inactivated by incubating the reaction vessel at e.g., 50° C. for 10 minutes while maintaining the integrity of the second and third gel layers. Then, the second gel layer is disrupted using a pipette tip, allowing the end repaired DNA to be mixed with the adapter ligation reagents. The reaction vessel is then incubated at e.g., 25° C. for 30 minutes to ligate the adapters to the DNA fragments. After this, the third gel layer is disrupted using a micropipette tip, allowing the ligation product to be mixed with the library amplification reagents. Finally, the reaction vessel is incubated through a PCR program to amplify the library, resulting in a library of DNA fragments that can be sequenced using NGS technology.

In ligation-mediated PCR embodiments, the reaction vessel is used to perform a variation of the PCR technique that amplifies a specific region of the DNA sequence. The process begins by adding intact DNA into the first layer of aqueous reagents containing either restriction enzyme or enzymatic fragmentation reagents, which break the DNA into smaller fragments. This step is performed using a micropipette tip that penetrates the top layer of penetrable gel. The reaction vessel is then incubated at e.g., 25° C.-37° C. for 30 minutes to allow the enzymes to work. Next, the reaction vessel is incubated at e.g., 50° C. for 10 minutes to inactivate the heat-labile enzymes while maintaining the integrity of the second and third gel layers. The second gel layer is then disrupted using a micropipette tip, allowing the fragmented DNA to be mixed with the adapter ligation reagents, which attach adapters to the ends of the DNA fragments. The reaction vessel is then incubated at e.g., 25° C. for 30 minutes to ligate the adapters to the DNA fragments. The third gel layer is then disrupted using a micropipette tip, allowing the ligation product to be mixed with the PCR reagents, which initiate the ligation-mediated PCR process. Finally, the reaction vessel is incubated through a PCR program, which amplifies the DNA fragments, producing large quantities of the targeted DNA sequence.

In some embodiments, the process involves a reaction vessel that has two distinct layers: a top layer of gel and a layer of aqueous reagents underneath. The aqueous reagents layer contains one or more specific fragmentation enzymes, end repair reagents, ligation reagents, or library amplification reagents, depending on the desired reaction. The top layer of gel allows for easy addition of the sample through a pipette tip that can penetrate the gel layers.

Once the sample has been added, the reaction vessel is incubated to allow the specific enzymatic fragmentation, end repair, ligation, or library amplification reactions to take place.

The incubation period may vary depending on the specific reaction and the desired outcome.

During this incubation period, the enzymatic reactions proceed in the aqueous reagents layer while the gel layer acts as a barrier to prevent contamination and ensure efficient reaction conditions.

In some embodiments of the described process, the reaction vessel contains two layers of aqueous reagents separated by two layers of gel. This configuration allows for the performance of two distinct enzymatic reactions in the same vessel.

In one possible configuration, the first layer of aqueous reagents may contain specific enzymatic fragmentation reagents or end repair reagents, depending on the desired reaction. For instance, on-bead tagmentation library prep uses bead-linked transposomes for a more uniform tagmentation reaction compared to in-solution tagmentation reactions. Bead-linked transposome chemistry integrates DNA extraction, fragmentation, library preparation, and library normalization steps. This reduces the number of workflow steps, requiring low sample input and reducing both hands-on and turnaround time.

These reagents are designed to break down DNA molecules into smaller fragments or to repair the DNA ends. The second layer of aqueous reagents may contain ligation reagents, which are used to add the adapters to the ends of DNA fragments.

In another possible configuration, the first layer of aqueous reagents contains ligation reagents, and the second layer may contain library amplification reagents. The ligation reagents in the first layer are used to add the adapters to the ends of the DNA fragments, which are then amplified in the second layer using library amplification reagents. This allows for the creation of multiple copies of the desired DNA fragments, which can be further analyzed or manipulated as needed.

In some embodiments, the PCR amplified libraries are purified by a bead cleanup method.

Magnetic beads and binding buffer are added to the finished library amplification reaction. The binding buffer facilitates the binding of the DNA libraries to the surface of the beads. The bead-DNA complexes are then separated from the liquid using a magnet rod, which is dipped into the reaction vessel to pull the beads out. Next, the magnet rod with the beads is dipped into 70% ethanol twice sequentially to wash the beads, removing any impurities that might have remained after the amplification reaction. Finally, the magnet rod with the beads is dipped into elution buffer allowing the DNA libraries to be eluted off the beads.

All publications, patents and patent applications, accession numbers, websites and the like mentioned in this specification are incorporated by reference to the same extent as if each individual publication, patent, or patent application was so individually denoted. To the extent different content is associated with an accession number or other reference at different times, the content in effect as of the effective filing date of this application is meant. The effective filing date is the date of the earliest priority application disclosing the accession number in question. Unless otherwise apparent from the context any element, embodiment, step, feature, or aspect of the invention can be performed in combination with any other.

### EXAMPLES

### Example 1: Preparation of Gels

To an aluminum wax melting reservoir with the inner dimensions of 100×140×50 mm was added 8 pieces of paraffin wax block with melting point of 50-52° C. Each of the wax blocks weighed 32 g and the total weight of the wax blocks was 256 g. The wax reservoir was thermostatic and heated to 75° C. which melted the wax blocks into a liquid form. The melted wax had a level height of about 25 mm in the reservoir. Then, mineral oil was added to the wax reservoir until the joint liquid level height reached 45 mm. The weight of the mineral oil added to the reservoir was determined as 234.5 g using bottle weight subtraction method. The resultant mixture of the wax and the mineral oil was stirred at 75° C. with a spatula until a homogeneous and clear liquid mixture was obtained which was ready to use for gel dispensing and making of gel-containing reaction vessels. The wax-to-mineral oil weight ratio of the melted mixture was 256 g/234.5 g or 1.09 (w/w); the wax-to-mineral oil volume ratio of the melted mixture was (100×140×25 mm/100×140× 20 mm) or 1.25 (v/v).

The melted mixture at 75° C. was dispensed into an 8-tube PCR tube strip using an 8-channel pipette that was equipped with an 8-aluminium nozzle adaptor. The 8-nozzle adaptor was heated at 75° C. with a thermostat temperature controller.

Pure wax of SUPELCO®, melting point 42-44° C., EMD Millipore was melted at 60° C. using the same wax reservoir as described above and dispensed into 8-tube PCR tube strips using the same 8-channel heated pipetted as described above.

### Example 2: Reagent-Free Reaction Tubes That Contain Pre-Loaded Single Layer of Gel

Four 0.1 mL 8-tube PCR strips were used to prepare for two different reaction tube types: i) gel containing tube strip; ii) gel and mineral oil dual layered tube strip. Performance of the resultant tube strips for amplification was evaluated in comparison with a liquid format in which no foreign materials were contained in the PCR tubes.

To prepare for gel containing tubes, 40 μL of liquified paraffin wax was added to each of the two tube strips. Dual layer tube strips containing gel were prepared by adding 30 μL of mineral oil first followed by 30 μL of gel overlay, which is a mixture of liquefied paraffin wax and mineral oil in volume ratio of 1.25:1.0 as described in Example 1. After the above tube strips were prepared, 10 μL of master mix, 9 μL of one-color (FAM) primer mix, and 1 μL of DNA template were added to each of the above tube strips, as well as to 12 tubes of empty tubes which serve as control of the liquid format. The tube strips added with reaction mixture were capped with lid strip and placed in cold block before being run on a Bio-Rad CFX96 thermal cycler. The thermal cycling is performed at a two-stage setting with the lid temperature set at 105° C.: 1) 90° C. for 0:15 and 60° C. for 0:30, repeating 9 cycles; 2) 95° C. for 0:15 and 65° C. for 0:30, repeating 39 cycles. FIG. 8 shows the representative amplification curves of the three formats of the tube reactions. Table 1 shows the results of Ct analysis on the amplification curves of the three tube formats. As can be seen, the dual layer tube strip performed comparably to the liquid format, whereas the wax alone format showed observable delay in Ct value and lower signals than did the two formers. FIG. 9 shows the photo images of the three tube types before and after thermal cycling, which indicates non-flowable, solidified wax or gel overlays sealed on top of the liquid reaction mixture in tubes.

TABLE 1
Results of PCR amplification curves of the three reaction tubes.

| | Gel | Gel-mineral | |
|---|---|---|---|
| Well | alone | oil | Liquid |
| 1 | 20.82 | 20.02 | 19.58 |
| 2 | 20.94 | 20.17 | 19.41 |
| 3 | 20.38 | 20.21 | 19.24 |
| 4 | 20.74 | 19.3 | 19.45 |
| 5 | 20.26 | 20 | 19.11 |
| 6 | 20.85 | 19.65 | 19.55 |
| 7 | 21.31 | 19.96 | 19.31 |
| 8 | 21.94 | 19.64 | 19.18 |
| 9 | 20.78 | 20.39 | 19.37 |
| 10 | 20.77 | 19.6 | 19.44 |
| 11 | 20.73 | 20.03 | 19.19 |
| 12 | 20.81 | 19.56 | 19.51 |
| 13 | 20.95 | 19.16 | |
| 14 | 20.32 | 18.8 | |
| 15 | 20.91 | 20.04 | |
| 16 | 20.43 | 19.35 | |
| Avg. | 20.83 | 19.77 | 19.36 |
| Stdev | 0.41 | 0.43 | 0.16 |
| CV | 1.94% | 2.20% | 0.80% |

Performance of these three tube formats was also evaluated using isothermal amplification reagents. For example, to each tube of the above three types of tube strip were added 10 μL of 4-color HPV screening primer mix, 10 μL of enzyme mix, and 5 μL of positive control template with two strips for each tube format. After being capped with a lid strip, the tube strips were placed in a cold block followed by loading them in the Bio-Rad thermal cycler to run isothermal reactions at constant temperature of 60° C. for 72 cycles. FIGS. 10A-C show the amplification curves of the three tube formats. Table 2 shows the results of Ct analysis on the amplification curves of the three reaction tubes. As can be seen, the three tube formats performed comparably in terms of amplification speed and precision by Ct analysis.

TABLE 2
Results of Ct analysis on 4-color amplification curves of the
three tube formats (dual layer format, gel alone format, and liquid format).

| | Gel-mineral oil | | | | Gel alone | | | | Liquid | | | |
|---|---|---|---|---|---|---|---|---|---|---|---|---|
| Well | FAM | HEX | ROX | Cy5 | FAM | HEX | ROX | Cy5 | FAM | HEX | ROX | Cy5 |
| 1 | 24.8 | 27.03 | 25.94 | 25.31 | 23.53 | 25.79 | 24.72 | 23.87 | 21.52 | 24.62 | 23.05 | 21.58 |
| 2 | 24.32 | 26.44 | 25.38 | 24.29 | 23.78 | 26.12 | 24.93 | 23.92 | 22.83 | 25.28 | 23.97 | 23.41 |
| 3 | 23.46 | 26.02 | 24.98 | 24.14 | 23.22 | 25.55 | 24.51 | 23.19 | 22.23 | 24.66 | 23.24 | 22.76 |
| 4 | 22.72 | 24.9 | 24.09 | 23.06 | 23.08 | 25.43 | 24.27 | 23.25 | 27.05 | 30.04 | 28.24 | 27.23 |
| 5 | 25.07 | 27.26 | 26.31 | 25.12 | 25.14 | 27.43 | 26.28 | 25.63 | 23.28 | 25.74 | 24.38 | 23.61 |
| 6 | 23.13 | 25.26 | 24.29 | 23.39 | 24.14 | 26.49 | 25.42 | 24.47 | 21.75 | 25.36 | 22.77 | 23.82 |
| 7 | 24.1 | 26.38 | 25.29 | 24.7 | 21.71 | 23.87 | 22.7 | 22.04 | 21.16 | 24.08 | 22.23 | 21.38 |
| 8 | 22.88 | 25.07 | 24.13 | 23.02 | 23.38 | 26.03 | 24.69 | 24.05 | 22.36 | 25.12 | 23.43 | 22.23 |
| 9 | 25.38 | 27.76 | 26.58 | 25.66 | 23.1 | 25.14 | 24.11 | 23.19 | 20.82 | 24.7 | 22.01 | 22.83 |
| 10 | 22.65 | 23.75 | 22.81 | 21.86 | 23.34 | 25.49 | 24.46 | 23.9 | 24.39 | 26.75 | 25.49 | 25.05 |
| 11 | 24.06 | 26.43 | 25.2 | 24.38 | 22.89 | 25.15 | 24.06 | 23.13 | 21.4 | 25.64 | 24.03 | 23.67 |
| 12 | 22.7 | 24.85 | 24.04 | 23.09 | 22.28 | 24.5 | 23.45 | 22.42 | 21.45 | 24.44 | 22.43 | 21.58 |
| 13 | 24.41 | 27.05 | 25.79 | 24.68 | 21.41 | 23.56 | 22.52 | 21.63 | 19.47 | 24.85 | 22.19 | 19.91 |
| 14 | 22.29 | 24.56 | 23.61 | 22.35 | 22.61 | 24.82 | 23.89 | 22.85 | 22.78 | 27.17 | 25.27 | 23.04 |
| 15 | 24.14 | 26.47 | 25.45 | 24.4 | 24.14 | 26.53 | 25.36 | 24.13 | 21.42 | 24.72 | 22.66 | 22.23 |
| 16 | 22.97 | 24.89 | 23.97 | 23.09 | 22.29 | 25.02 | 23.38 | 22.33 | 24.2 | 26.25 | 25.18 | 24.56 |
| Avg. | 23.69 | 25.88 | 24.87 | 23.91 | 23.13 | 25.43 | 24.30 | 23.38 | 22.38 | 25.59 | 23.79 | 23.06 |
| CV | 4.07% | 4.43% | 4.24% | 4.60% | 4.10% | 3.91% | 4.07% | 4.33% | 7.88% | 5.71% | 6.91% | 7.40% |

### Example 3: Multilayer Reaction Tubes Contain Pre-Loaded Reagents and Gel Layers

Preparation of a tube strip that contains the gel-mineral oil mixture and a PCR reagent is described as follows. To each tube of a 0.1 mL 8-tube PCR strips was added 10 μL of one-color primer mix, followed by mineral oil as a second layer, a gel layer as a third layer, 10 μL of enzyme mix as a fourth layer, mineral oil as a fifth layer, and a gel as a sixth layer. The two gel layers in this experiment are the same in composition as that described in Example 2. The PCR reagent used in this experiment is the same as that described in Example 2.

To use the resultant reagent tubes for PCR reactions, the foil seal was peeled off from the tube strip, and the two gel layers were poked through and broken apart using a needle like plastic pick. Then, 1 μL of a PCR positive control template was added to the liquid phase of the tubes through the broken opening of the gel layers using a conventional pipette, followed by capping the sample-added tube strips with caps. The capped tube strip was centrifuged using a microfuge for a few seconds. Finally, the centrifuged tube strip was placed in a cold block before being placed in a Bio-Rad thermal cycler for sample run. The thermal cycling is performed at a two-stage setting with the lid temperature set at 105° C.: 1) 90° C. for 0:15 and 60° C. for 0:30, repeating 9 cycles; 2) 95° C. for 0:15 and 65° C. for 0:30, repeating 39 cycles, which is the same thermal cycling setting as that described in Example 2. FIG. 11 shows the amplification curves of the reactions with the two multilayer PCR reagent tube strips. Table 3 shows the results of Ct analysis on the amplification curves shown in FIG. 11 which indicates amplification speed and precision comparable to those shown in Table 1. FIG. 12 shows the photo images of the tube strip before and after thermal cycling, which indicates non-flowable, solidified gel overlays sealed on top of the liquid reaction mixture in tubes.

TABLE 3
Results of Ct analysis on the PCR amplification curves of the
multilayer reagent tubes.

| | Multilayered |
|---|---|
| Well | reagent |
| 1 | 19.82 |
| 2 | 18.48 |
| 3 | 18.63 |
| 4 | 18.88 |
| 5 | 19.39 |
| 6 | 18.24 |
| 7 | 19.35 |
| 8 | 18.62 |
| 9 | 19.21 |
| 10 | 18.62 |
| 11 | 19.46 |
| 12 | 18.5 |
| 13 | 18.62 |
| 14 | 19 |
| 15 | 19.26 |
| 16 | 19.17 |
| Avg. | 18.94 |
| CV | 2.34% |

In parallel to the PCR reagent tubes as described above, multilayer isothermal amplification reagent tubes were also prepared and performance-evaluated in comparison with the liquid format, as described below. A 0.2 mL 8-tube multilayer UTI (urinary tract infection) testing tube strip was prepared in the same manner as that described above. The resultant multilayer reagent tubes have the following layer configuration in order (from bottom to top): 10 μL of enzyme mix, mineral oil, gel layer, 10 μL of 4-color UTI primer mix, mineral oil, and gel layer. The completed tube strip was sealed with an adhesive foil strip. After peeling off the foil seal from the tube strip, the two layers of the wax-mineral oil gel barrier were poked through and broken apart using a needle like plastic pick. Then, 5 μL of a UTI positive control template was added to the liquid phase of the tubes through the broken opening of the wax-oil gel layers using a conventional pipette, followed by capping the sample-added tube strips with a lid strip. The capped tube strip was centrifuged using a microfuge for a few seconds. Finally, the centrifuged tube strip was placed in a cold block which was ready to run on a thermal cycler. The reaction tubes of the liquid format were prepared with an empty 0.2 mL PCR tube strip which involved pipetting 10 μL of enzyme mix, 10 μL of 4-color UTI primer mix, and 5 μL of UTI positive control template to each tube of the strip. After centrifuged briefly with a microfuge, the completed tube strip was placed in a Bio-Rad CFX96 thermal cycler alongside the multilayer reagent tube strip, which was run at constant temperature of 60° C. for 72 cycles or 90 minutes. FIGS. 13A-D shows the 4-color amplification curves of the reactions with the multilayer UTI isothermal reagent tube strip and the control liquid format. Table 4 shows the results of Ct analysis on the amplification curves shown in FIGS. 13A-D which indicates amplification speed and precision of the multilayer UTI reagent tubes performed comparably to those of the liquid format. FIG. 14 shows photo images of the multilayer reagent tube strip before (top) and after (bottom) isothermal amplification at 60° C. for 90 minutes, illustrating extensive solidified gel overlay formed on top of the liquid layer in the tubes after sample run.

TABLE 4
Results of Ct analysis on the amplification curves
of the multilayer reagent tubes and liquid format tubes.

| | Multilayer | | | | Liquid | | | |
|---|---|---|---|---|---|---|---|---|
| Well | FAM | HEX | ROX | Cy5 | FAM | HEX | ROX | Cy5 |
| 1 | 15.4 | 15.44 | 15.58 | 15.71 | 14.32 | 15.99 | 17.69 | 16.75 |
| 2 | 15.38 | 15.41 | 15.75 | 15.64 | 14.51 | 15.09 | 16.63 | 16.96 |
| 3 | 11.19 | 10.15 | 12.04 | 12.44 | 14 | 18.23 | 18.85 | 18.92 |
| 4 | 12.65 | 13.16 | 13.38 | 13.49 | 13.18 | 22.37 | 22.39 | 22.95 |
| 5 | 12.73 | 13.27 | 13.73 | 13.79 | 14.09 | 14.82 | 15.58 | 15.52 |
| 6 | 14.3 | 14.57 | 14.98 | 15.25 | 13.38 | 16.88 | 17.77 | 17.51 |
| 7 | 12.5 | 13.06 | 13.3 | 13.71 | 13.21 | 18.57 | 19.2 | 19.2 |
| 8 | 16.21 | 16.19 | 16.88 | 16.66 | 14.31 | 15.2 | 15.84 | 16.02 |
| Avg. | 13.80 | 13.91 | 14.46 | 14.59 | 13.88 | 17.14 | 17.99 | 17.98 |
| CV | 12.88% | 13.87% | 11.08% | 9.81% | 3.87% | 14.84% | 12.24% | 13.25% |

To evaluate performance of the multilayer reagent tubes in assay sensitivity, HPV31 positive control template at a limit of detection concentration of 7.5 copies per 25 μL of reaction was added to a HPV31 reagent tube strip which was run on the Bio-Rad thermal cycler at temperature of 60° C. for 90 minutes. A liquid control run was performed alongside the HPV31 reagent tube strip. FIG. 15 shows the amplification curves (FAM channel) of the reactions with the HPV31 reagent tube strip and the liquid tube strip which indicated comparable assay sensitivity for these two reagent formats.

### Example 4: Evaluation of the Multilayer Reagent Tubes with HPV Clinical Sample

The multilayer HPV screening reagent tube strips were evaluated with clinical HPV samples. Two HPV reagents tube strips, i.e., HPV16 (FAM channel) and HPV18 (Cy5 channel), were used to perform HPV screening assay on 78 HPV samples. These HPV samples are lysis treated swab specimens collected from 78 patients. The HPV reagent tube strips for this evaluation study were prepared in the same manner as that described in Example 2. The sample volume was 5 μL with a total volume of 16 μL (4×4) being used to perform 4 replicates of the amplification reaction for each of the 78 samples. The isothermal sample run of these samples was performed using the same heating condition as that as described in Example 2. Table 5 summarizes the results of the screening assay performed on the 78 HPV samples indicating good agreement between the multilayer reagent format and the conventional liquid format.

TABLE 5
Results of the HPV screening assay on the 78 HPV samples (ND -
not detectable; HR - high risk)

| Sample ID | Multilayer | Liquid |
|---|---|---|
| 91 | ND | ND |
| 92 | 16 | 16 |
| 93 | 16 | 16 |
| 94 | ND | ND/Fail |
| 95 | ND | HR |
| 96 | ND | ND |
| 97 | 16 | 16 |
| 98 | 16 | 16/ND |
| 99 | HR | HR |
| 100 | ND | ND |
| 101 | ND | ND |
| 102 | HR | HR |
| 103 | ND | ND |
| 104 | ND | ND |
| 105 | ND | ND |
| 106 | ND | ND |
| 107 | Fail | Fail |
| 108 | ND | ND |
| 109 | ND | ND |
| 110 | ND | ND |
| 111 | ND | ND |
| 112 | ND | ND |
| 113 | ND | ND |
| 114 | HR | HR |
| 115 | ND | ND |
| 116 | HR | HR |
| 117 | 16 | 16 |
| 118 | 16 | 16 |
| 119 | 16, HR | 16, HR |
| 120 | HR | HR |
| 121 | 16 | 16 |
| 122 | HR | HR |
| 123 | 16 | 16 |
| 124 | ND | ND |
| 125 | 16 | 16 |
| 126 | 16, HR | 16, HR |
| 127 | ND | ND |
| 128 | 16, HR | 16, HR |
| 129 | HR | HR |
| 130 | ND | ND |
| 131 | ND | ND |
| 132 | HR | HR |
| 133 | ND | ND |
| 134 | 16 | 16 |
| 135 | ND | ND |
| 136 | ND | ND |
| 137 | 16 | 16 |
| 138 | 16, HR | 16, HR |
| 139 | ND/HR | ND/Fail |
| 140 | 16 | 16 |
| 141 | 16 | 16 |
| 142 | HR | HR |
| 143 | 16 | 16 |
| 144 | HR | HR |
| 145 | ND | ND |
| 146 | 16 | 16 |
| 147 | ND | ND |
| 148 | 16 | 16 |
| 149 | 16 | 16 |
| 150 | 16 | 16 |
| 151 | HR | HR |
| 152 | 16 | 16 |
| 153 | 16 | 16 |
| 154 | 16 | 16 |
| 155 | 16, HR | 16, HR |
| 156 | ND | ND |
| 157 | ND | ND |
| 158 | 16/ND | 16/ND |
| 159 | ND | ND |
| 162 | 16 | 16 |
| 163 | HR | HR |
| 164 | HR | HR |
| 165 | Fail | Fail |
| 166 | ND | ND |
| 167 | Fail | Fail |
| 168 | ND | ND |
| 169 | 16 | 16 |
| 170 | ND | ND |

### Example 5: Stability of the Multilayer Reagent Tubes

Physical or mechanical stability of the multilayer reagent tubes was evaluated by dropping the reagent tube strips on floor from height of about 10 feet above the floor. The purpose of this study was to examine the adherence of the two wax-mineral oil gel layers to the tube wall after experiencing free fall impact on hard surfaces. Prior to this fall-impact experiment, 12 reagent tube strips sitting in a plate holder were stored at −20° C. overnight. In the next day, the strip plate was removed from the −20° C. condition and allowed to equilibrate to ambient temperature for about 15 minutes. Then, the 12 strips were allowed to drop to the lab floor from a height of about 10 feet and repeated two times for these 12 strips. FIGS. 16A, B shows the photo images of the 12 tube strips before and after the falling impact. Visual inspection of the tube strips indicated good and stable adherence of the two wax-mineral oil layers to the tube inner wall after three times of free-falling drop, suggesting good physical stability and viability of the tube strips for transport and handling under moderate impact condition.

Thermal stressing stability of the multilayer reagent tubes was evaluated by simulating long time transport conditions at ambient temperature and storing the reagent tube strips in a commuter vehicle. For comparison purposes, 5-layer reagent tube strips without the mineral oil layer encapsulating the reagent component at bottom of the tube were prepared and compared with the regular 6-layer tube strips as described in Example 2.

In this experiment, six strips of 6-layer 4-color HPV18 reagent tubes and six strips of 4-color 5-layer HPV18 reagent were stored at −20° C. condition overnight. In the next day, the strips were removed and placed on lab bench for about 7 hours at room temperature (20 to 25° C.). Then, the strips were stored at −20° C. condition overnight, again. After repeating this freeze/thaw process three times, the strip plates were packed in a sealed foam box without coolant which was placed in the trunk of a commute vehicle for consecutive 4 days of daily commute travel. The temperature inside the foam box was in the range of 15-30° C. as recorded with a temperature logger. Then, the tube strips were removed from the package and placed on lab bench for reaction preparation which was described in Example 2. Briefly, to each of the tube strips for the two types of layer format was added 5 μL of HPV18 positive template at a Lod (limit of detection) concentration of 15 copies per reaction. The sample-added tube strips were run on a Bio-Rad thermal cycler at 60° C. for 90 minutes. FIGS. 17A, B shows the FAM and ROX amplification curves of the two types of tube strips with repeated freeze/thaw cycle and long-time transport at ambient temperature (curves in the HEX and Cy5 channels were not shown). As can be seen, reagents stored in the 5-layer tubes show drastically elevated background signals in the FAM channel and increased Ct values compared with those stored in the 6-layer tubes.

In view of the effectiveness of reagent segregation rendered by the multilayering design, thermal stability of these multilayer reaction tubes at elevated temperatures was accessed. Table 6 shows the thermal stability results of the 6-layer reagent tubes at ambient temperatures ranging from 23 to 45° C. In the thermal stability experiment, it was observed that when the tube strips were exposed to elevated temperature that were closed to the melting point of the gel layers for a period of time, e.g., 40° C. for 39 minutes, majority of the gel layers became thinner and ultimately lost adhesion to the inner wall of the tubes, causing the second aqueous layer to fall through the gel barrier and merge with the first aqueous layer at bottom of the tube. To improve thermal stability of these 6-layer reaction tubes, increasing fraction of the wax component in the wax-oil gel extends the tube failure time but at the cost of increasing hardness of the resultant gel layers for penetration with the pipette tips.

| Ambient temperature | Tube failure time |
|---|---|
| 23° C. | >7 months |
| 35° C. | 2 days |
| 40° C. | 39 min |
| 45° C. | 2 - 3 min |

What is claimed is:

1. A reaction vessel comprises a gel layer penetrable by a micropipette tip disposed within the vessel.

2. The reaction vessel of claim 1, further comprising one or more additives in the gel layer and mineral oil underneath the gel layer.

3. The reaction vessel of claim 1 or 2, further comprising a liquid aqueous reaction mixture above and/or below and/or or within the gel layer, optionally, wherein the liquid aqueous reaction mixture(s) are for detection of an analyte.

4. The reaction vessel of claim 3, wherein the liquid aqueous reaction mixture is below the gel layer, the gel layer resists dispersal of the liquid aqueous reaction mixture across the gel layer, and the gel layer is penetrable by a micropipette tip to deliver a solution to the reaction mixture for a reaction to detect an analyte.

5. The reaction vessel of claim 3, wherein the delivered solution is a sample including the analyte.

6. The reaction vessel of claim 5, wherein the gel layer resists dispersal of the liquid aqueous reaction mixture across the gel layer and is penetrable by a micropipette tip at least within a temperature range of 18-35° C., optionally 20-25° C.

7. The reaction vessel of any one of claims 1 to 6, wherein the reaction vessel comprises multiple gel layers, multiple oil layers, and multiple liquid aqueous reaction mixture layers, the number of gel layers differing from the number of oil layers, and/or from the number of liquid aqueous reaction mixture layers.

8. The reaction vessel of any one of claims 1-7, wherein the micropipette comprises a single tip or multiple tips or a bundle of capillaries.

9. The reaction vessel of any preceding claim, comprising:
a first liquid aqueous reaction mixture, a first gel layer penetrable by a micropipette tip covering the first liquid aqueous reaction mixture, a second liquid aqueous reaction mixture over the first gel layer; and
a second gel layer penetrable by a micropipette tip covering the second liquid aqueous solution; and
optionally, a first layer of mineral oil between the first liquid aqueous reaction mixture and the first gel layer, and optionally, a second layer of mineral oil between the second liquid aqueous reaction mixture and the second gel layer.

10. The reaction vessel of claim 9, wherein one of the first and second liquid aqueous reaction mixtures is a sample and the other contains one or more reagents for performing a reaction to detect an analyte in the sample when first and second liquid aqueous reaction mixtures are combined.

11. The reaction vessel of claim 9, wherein the first liquid aqueous reaction mixture and the second liquid aqueous reaction mixtures are each partial reaction mixtures which when combined with each other and a sample result in a detection reaction.

12. The reaction vessel of claim 9, wherein optionally a third liquid aqueous reaction mixture is present above the second gel layer and the multiple liquid aqueous reaction mixtures contain reagents for performing ordered bioprocessing steps.

13. The reaction vessel of claim 12, where the multiple liquid aqueous reaction mixtures are for performing nucleic acid sequencing library preparation or nucleic acid sample extraction or immunoassay, or biochemistry or nucleic acid amplification and detection.

14. The reaction vessel of claim 12, wherein the first liquid aqueous reaction mixture and second liquid aqueous reaction mixture contain polymerases and primers respectively or vice versa for nucleic acid detection with PCR amplification, qPCR amplification, reverse transcriptase PCR reaction or digital PCR amplification or isothermal amplification.

15. The reaction vessel of claim 12, wherein the first liquid aqueous reaction mixture and second liquid aqueous reaction mixture contain different reagents, which in combination with each other and sample are required for a detection reaction.

16. The reaction vessel of claim 15, wherein the combination of the first liquid aqueous reaction mixture and the second liquid aqueous reaction mixture is for performing an immunoassay and detection, optionally a third liquid aqueous reaction mixture is above the second gel layer for sequential reactions.

17. The reaction vessel of claim 3, wherein the liquid aqueous reaction mixture contains magnetic beads.

18. The reaction vessel of any preceding claim coupled to a slidable heater module along the exterior of the reaction vessel for melting the gel layer when the heater adjacent to the gel layer.

19. The reaction vessel of any preceding claim coupled to a slidable magnetic module along an exterior or interior surface of the reaction vessel for moving magnetic beads from a liquid aqueous reaction mixture across a layer of the gel underneath the liquid aqueous reaction mixture.

20. The reaction vessel of claim 19, wherein the slidable magnetic module is slidable along the interior of the reaction vessel and is linked to a rod to detect a reaction in the reaction vessel.

21. The reaction vessel of claim 3, wherein the liquid aqueous reaction mixture comprises a rod for detection of a reaction in the reaction vessel.

22. The reaction vessel of claim 21, wherein the rod is an electrode.

23. The reaction vessel of any preceding claim, which is a well in a multi-well plate (e.g., a PCR plate or deep well plate or microtiter plate or ELISA plate), each of the wells containing a gel layer.

24. The reaction vessel of any one of claims 1-22, which is a tube or tubing (e.g., a PCR tube) disposed singularly or as a strip or matrix, comprising a plurality of the vessel interconnected to one another.

25. The reaction vessel of any one of claims 1-22 that is a plastic, glass or metal with one or multiple trenches or channels.

26. The reaction vessel of any one of claims 1-23 that is a well on a chip or tubing (e.g., glass slides or silicon wafers or plastic slides or metal slides), optionally having multiple wells providing multiple reaction vessels, and optionally the multiple wells are connected by channels, and optionally the wells contain a piece of membrane or glass fiber.

27. The reaction vessel of any preceding claim, wherein an inner surface of the reaction vessel is hydrophobic or hydrophilic.

28. The reaction vessel of any preceding claim, wherein the gel layer is made of an inorganic or organic or combination of inorganic and organic polymer gel matrix or is a mixture of wax and mineral oil or silicon oil in a ratio from 25:75 to 75:25 by weight with or without surfactant additives.

29. A method of performing a reaction comprising providing a reaction vessel as defined by claim 1 and penetrating the layer of the gel with a micropipette tip to deliver a solution from the micropipette tip, whereby a reaction occurs.

30. The method of claim 29, wherein the solution comprises a sample, and optionally reaction reagents.

31. The method of claim 29 or 30, wherein the gel layer melts during and after the reaction and re-solidifies thereafter.

32. The method of any one of claims 29-31, further comprising disrupting the gel layer with an inert rod or a micropipette tip with a plug in it before penetrating the gel with the micropipette tip to deliver one or more liquid aqueous reaction mixtures to the reaction vessel.

33. The method of claim 32, wherein the plug in the tip is wax or gel.

34. The method of any one of claim 29-33, wherein the reaction vessel comprises a first liquid aqueous reaction mixture below a first gel layer and a second liquid aqueous reaction mixture above the first gel layer, and a second gel layer above the second liquid aqueous reaction mixture and the method comprises penetrating the gel layers with an inert rod or a micropipette tip to mix the first liquid aqueous reaction mixture and the second liquid aqueous reaction mixture, whereby the reaction vessel comprises a mixed reaction mixture covered by a third gel layer formed from the first and second gel layers and the method further comprises penetrating the third gel layer with the micropipette tip to deliver the solution from the micropipette tip to the mixed reaction mixture.

35. The method of claim 34, further comprising centrifuging the reaction vessel to facilitate mixing the reaction mixtures between the gel layers.

36. The method of any one of claims 29-35, wherein the solution is a liquid aqueous reaction mixture comprising all reaction reagents including a sample for a reaction to detect a target in the sample or partial reaction reagents for a reaction to detect a target in the sample.

37. The method of any one of claims 29-36, wherein the liquid aqueous reaction mixture is delivered into an oil layer or gel layer to form emulsion droplets or other reaction compartments for droplet digital PCR reaction or droplet immunoassay PCR reactions.

38. A method of performing a reaction comprising providing a reaction vessel as defined by claim 1 and solutions placed above and beneath the gel layer, and displacing or melting the gel layer, whereby the solutions mix and a reaction occurs.

39. A reaction vessel comprising a plurality of liquid aqueous reaction mixtures separated from one another by a plurality of gel layers disposed with the reaction vessel, wherein the plurality of liquid aqueous reaction mixtures are combinable by melting and/or disruption of the gel layers to perform a series of processing steps in order.

40. The reaction vessel of claim 39, further comprising a layer of mineral oil below one or more of the gel layers.

41. The reaction vessel of claim 39 or 40, coupled to a heater slidable along the exterior surface of the reaction vessel for melting a gel layer adjacent the heater.

42. The reaction vessel of any one of claims 39-41, wherein at least one liquid aqueous reaction mixture comprises magnetic beads and the reaction vessel is coupled to a magnet slidable along an exterior surface of the reaction vessel for moving magnetic beads through a gel layer underneath the liquid aqueous reaction mixture comprising the magnetic beads.

43. The reaction vessel of any one of claims 39-42, wherein the gel is a mixture of paraffin wax and mineral oil or silicon oil in a volumetric or weight ratio ranging from 99:1 to 25:75.

44. The reaction vessel of any one of claims 39-43, wherein the liquid aqueous reaction mixtures contain reagents for performing ordered steps of an integrated immunoassay.

45. The reaction vessel of any one of claims 39-43, wherein the liquid aqueous reaction mixtures contain different reagents for ordered bioprocessing steps, optionally for ordered steps in an immunoassay.

46. The reaction vessel of any one of claims 39-45, wherein the liquid aqueous reaction mixtures each contains one or more of magnetic beads, capture antibodies, washing solution, detection antibodies, enzymes, substrate, stop solution for performing ordered steps of an integrated immunoassay.

47. The reaction vessel of any one of claims 39-46, wherein the liquid aqueous reaction mixtures each contain one or more of lysis buffer, DNA/RNA binding solution, magnetic beads, washing buffer, and elution buffer for performing ordered steps of an integrated DNA/RNA purification.

48. The reaction vessel of any one of claims 39-47, wherein the liquid aqueous reaction mixtures each contain one or more of a fragmentation enzyme or end repair reagent, ligation reagent, library amplification reagents for performing ordered steps of integrated NGS library preparation.

49. A method of performing a reaction, comprising providing the reaction vessel of any one of claims 37-46; melting one of the gel layers and thereby combining liquid aqueous reaction mixtures above and below the layer to initiate a reaction.

50. The method of claim 49, wherein the reaction vessel is coupled to a heater slidable on an exterior surface of the reaction vessel and moving the heater along the surface to a position where it can melt one of the gel layers.

51. The method of claim 49 or 50, wherein the heater is part of a module.

52. The method of claim 50 or 51, wherein the heater is a thermoelectric device.

53. The method of any one of claims 50-52, wherein the thermoelectric heating element is a semiconductor-based Peltier device.

54. The method of any one of claims 50-52, wherein the module further comprises a cooling element for resolidifying a gel layer after melting.

55. The method of any one of claims 50-54, wherein the module is linked to a magnetic module for moving magnetic beads.

56. The method of claim 55, wherein the magnet is an electromagnet.

57. A method of performing a reaction, comprising providing the reaction vessel of claim 18 coupled to a slidable magnetic module on an exterior surface of the reaction vessel or interior surface of the reaction vessel, wherein at least one of the liquid aqueous reaction mixtures comprises magnetic beads and moving the slidable magnetic module along the exterior or interior surface to a position where it can move the beads.

58. The method of claim 57, wherein the slidable magnetic module is linked to one of more the following modules: a mechanical module, a heat module, an electrical module, a magnetic module, an optical module to assist a reaction in the reaction vessel and detect the reaction in the reaction vessel in real time or after the reaction finished.

59. The method of claim 57, wherein the reaction vessel is linked to a device for processing a sample or reagents and detecting chemical or physical changes due to a reaction in the reaction vessel, such as color, fluorescent, luminescent, chemiluminescent, electrical chemistry, radiation, reflection, phase changes, magnetic resistance, turbidity, mobility shift, pH, or ionic strength.

60. A reaction vessel containing a first layer of gel comprising a first aqueous reaction mixture and optionally a second layer of gel comprising a second aqueous reaction mixture, and optionally a third aqueous reaction mixture or samples on top of the second gel layer, the gels meltable on heating to mix the aqueous reaction mixtures.

61. The reaction vessel of claim 60, further comprising a layer of oil with a density greater than that of water above the second layer of gel.
